(19) United States
(12) Patent Application Publication
(10) Pub. No.: US 2025/0301556 A1
(43) Pub. Date: Sep. 25, 2025

(54) TECHNIQUES FOR ILLUMINATING A PHYSICAL SPACE

(71) Applicant: Apple Inc., Cupertino, CA (US)

(72) Inventors: Jean-Pierre M. MOUILLESEAUX, San Carlos, CA (US); Felipe BACIM DE ARAUJO E SILVA, San Jose, CA (US); Karlin Y. BARK, San Carlos, CA (US)

(21) Appl. No.: 19/056,080

(22) Filed: Feb. 18, 2025

Related U.S. Application Data
(60) Provisional application No. 63/567,778, filed on Mar. 20, 2024.

(51) Int. Cl. H05B 47/175; G06T 13/00

(52) U.S. Cl. CPC H05B 47/196; G06T 13/00; G06T 2200/24

(57) ABSTRACT

The present disclosure generally relates to illuminating a physical space, such as duplicating lighting conditions of an external environment, simulating light conditions, and/or storing one or more characteristics of lighting conditions.

### CROSS-REFERENCE TO RELATED APPLICATIONS

The present application claims priority to U.S. Provisional Patent Application Ser. No. 63/567,778, entitled “TECHNIQUES FOR ILLUMINATING A PHYSICAL SPACE,” filed Mar. 20, 2024, which is hereby incorporated by reference in its entirety for all purposes.

### FIELD

The present disclosure relates generally to computer user interfaces, and more specifically to techniques for illuminating a physical space.

### BACKGROUND

Electronic devices often control the illumination of physical space. The electronic devices can tailor the illumination of the physical space based on a user's preferences.

### SUMMARY

Some techniques for illuminating a physical space using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for illuminating a physical space. Such methods and interfaces optionally complement or replace other methods for illuminating a physical space. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a light source, an input device, and an output device is described. In some embodiments, the method comprises: while an environment is being illuminated by the light source, detecting, via the input device, a request to save an illumination state of the environment; and in conjunction with detecting the request to save the illumination state of the environment: storing the illumination state of the environment, wherein the illumination state includes a first diffusion pattern present in the environment; and outputting, via the output device, an indication that the illumination state has been saved.

In some embodiments, a non-transitory computer-readable storage medium storing one or more programs configured to be executed by one or more processors of a computer system that is in communication with a light source, an input device, and an output device is described. In some embodiments, the one or more programs includes instructions for: while an environment is being illuminated by the light source, detecting, via the input device, a request to save an illumination state of the environment; and in conjunction with detecting the request to save the illumination state of the environment: storing the illumination state of the environment, wherein the illumination state includes a first diffusion pattern present in the environment; and outputting, via the output device, an indication that the illumination state has been saved.

In some embodiments, a transitory computer-readable storage medium storing one or more programs configured to be executed by one or more processors of a computer system that is in communication with a light source, an input device, and an output device is described. In some embodiments, the one or more programs includes instructions for: while an environment is being illuminated by the light source, detecting, via the input device, a request to save an illumination state of the environment; and in conjunction with detecting the request to save the illumination state of the environment: storing the illumination state of the environment, wherein the illumination state includes a first diffusion pattern present in the environment; and outputting, via the output device, an indication that the illumination state has been saved.

In some embodiments, a computer system configured to communicate with a light source, an input device, and an output device is described. In some embodiments, the computer system comprises one or more processors and memory storing one or more programs configured to be executed by the one or more processors. In some embodiments, the one or more programs includes instructions for: while an environment is being illuminated by the light source, detecting, via the input device, a request to save an illumination state of the environment; and in conjunction with detecting the request to save the illumination state of the environment: storing the illumination state of the environment, wherein the illumination state includes a first diffusion pattern present in the environment; and outputting, via the output device, an indication that the illumination state has been saved.

In some embodiments, a computer system configured to communicate with a light source, an input device, and an output device is described. In some embodiments, the computer system comprises means for performing each of the following steps: while an environment is being illuminated by the light source, detecting, via the input device, a request to save an illumination state of the environment; and in conjunction with detecting the request to save the illumination state of the environment: storing the illumination state of the environment, wherein the illumination state includes a first diffusion pattern present in the environment; and outputting, via the output device, an indication that the illumination state has been saved.

In some embodiments, a computer program product is described. In some embodiments, the computer program product comprises one or more programs configured to be executed by one or more processors of a computer system that is in communication with a light source, an input device, and an output device. In some embodiments, the one or more programs include instructions for: while an environment is being illuminated by the light source, detecting, via the input device, a request to save an illumination state of the environment; and in conjunction with detecting the request to save the illumination state of the environment: storing the illumination state of the environment, wherein the illumination state includes a first diffusion pattern present in the environment; and outputting, via the output device, an indication that the illumination state has been saved.

In some embodiments, a method that is performed at a computer system that is in communication with an external light source and an input device is described. In some embodiments, the method comprises: detecting, via the input device, a request to illuminate a first physical space based on a second physical space different from the first physical space, wherein the second physical space is outside of the first physical space; and in response to detecting the request to illuminate the first physical space based on the second physical space: in accordance with a determination that the second physical space has a first context, illuminating, via the external light source, a first region of the first physical space in a first manner without illuminating a second region of the first physical space in the first manner, wherein the second region is different from the first region; and in accordance with a determination that the second physical space has a second context different from the first context, illuminating, via the external light source, the first region of the first physical space in a second manner different from the first manner.

In some embodiments, a non-transitory computer-readable storage medium storing one or more programs configured to be executed by one or more processors of a computer system that is in communication with an external light source and an input device is described. In some embodiments, the one or more programs includes instructions for: detecting, via the input device, a request to illuminate a first physical space based on a second physical space different from the first physical space, wherein the second physical space is outside of the first physical space; and in response to detecting the request to illuminate the first physical space based on the second physical space: in accordance with a determination that the second physical space has a first context, illuminating, via the external light source, a first region of the first physical space in a first manner without illuminating a second region of the first physical space in the first manner, wherein the second region is different from the first region; and in accordance with a determination that the second physical space has a second context different from the first context, illuminating, via the external light source, the first region of the first physical space in a second manner different from the first manner.

In some embodiments, a transitory computer-readable storage medium storing one or more programs configured to be executed by one or more processors of a computer system that is in communication with an external light source and an input device is described. In some embodiments, the one or more programs includes instructions for: detecting, via the input device, a request to illuminate a first physical space based on a second physical space different from the first physical space, wherein the second physical space is outside of the first physical space; and in response to detecting the request to illuminate the first physical space based on the second physical space: in accordance with a determination that the second physical space has a first context, illuminating, via the external light source, a first region of the first physical space in a first manner without illuminating a second region of the first physical space in the first manner, wherein the second region is different from the first region; and in accordance with a determination that the second physical space has a second context different from the first context, illuminating, via the external light source, the first region of the first physical space in a second manner different from the first manner.

In some embodiments, a computer system configured to communicate with an external light source and an input device is described. In some embodiments, the computer system comprises one or more processors and memory storing one or more programs configured to be executed by the one or more processors. In some embodiments, the one or more programs includes instructions for: detecting, via the input device, a request to illuminate a first physical space based on a second physical space different from the first physical space, wherein the second physical space is outside of the first physical space; and in response to detecting the request to illuminate the first physical space based on the second physical space: in accordance with a determination that the second physical space has a first context, illuminating, via the external light source, a first region of the first physical space in a first manner without illuminating a second region of the first physical space in the first manner, wherein the second region is different from the first region; and in accordance with a determination that the second physical space has a second context different from the first context, illuminating, via the external light source, the first region of the first physical space in a second manner different from the first manner.

In some embodiments, a computer system configured to communicate with an external light source and an input device is described. In some embodiments, the computer system comprises means for performing each of the following steps: detecting, via the input device, a request to illuminate a first physical space based on a second physical space different from the first physical space, wherein the second physical space is outside of the first physical space; and in response to detecting the request to illuminate the first physical space based on the second physical space: in accordance with a determination that the second physical space has a first context, illuminating, via the external light source, a first region of the first physical space in a first manner without illuminating a second region of the first physical space in the first manner, wherein the second region is different from the first region; and in accordance with a determination that the second physical space has a second context different from the first context, illuminating, via the external light source, the first region of the first physical space in a second manner different from the first manner.

In some embodiments, a computer program product is described. In some embodiments, the computer program product comprises one or more programs configured to be executed by one or more processors of a computer system that is in communication with an external light source and an input device. In some embodiments, the one or more programs include instructions for: detecting, via the input device, a request to illuminate a first physical space based on a second physical space different from the first physical space, wherein the second physical space is outside of the first physical space; and in response to detecting the request to illuminate the first physical space based on the second physical space: in accordance with a determination that the second physical space has a first context, illuminating, via the external light source, a first region of the first physical space in a first manner without illuminating a second region of the first physical space in the first manner, wherein the second region is different from the first region; and in accordance with a determination that the second physical space has a second context different from the first context, illuminating, via the external light source, the first region of the first physical space in a second manner different from the first manner.

In some embodiments, a method that is performed at a computer system in communication with an external light source and an input device is described. In some embodiments, the method comprises: while illuminating, according to a first time of day, a first space via the external light source, detecting, via the input device, an input; and in response to detecting the input: in accordance with a determination that the input corresponds to a second time of day different from the first time of day, illuminating, according to the second time of day, the first space via the external light source; and in accordance with a determination that the input corresponds to a third time of day different from the first time of day and the second time of day, illuminating, according to the third time of day, the first space via the external light source.

In some embodiments, a non-transitory computer-readable storage medium storing one or more programs configured to be executed by one or more processors of a computer system in communication with an external light source and an input device is described. In some embodiments, the one or more programs includes instructions for: while illuminating, according to a first time of day, a first space via the external light source, detecting, via the input device, an input; and in response to detecting the input: in accordance with a determination that the input corresponds to a second time of day different from the first time of day, illuminating, according to the second time of day, the first space via the external light source; and in accordance with a determination that the input corresponds to a third time of day different from the first time of day and the second time of day, illuminating, according to the third time of day, the first space via the external light source.

In some embodiments, a transitory computer-readable storage medium storing one or more programs configured to be executed by one or more processors of a computer system in communication with an external light source and an input device is described. In some embodiments, the one or more programs includes instructions for: while illuminating, according to a first time of day, a first space via the external light source, detecting, via the input device, an input; and in response to detecting the input: in accordance with a determination that the input corresponds to a second time of day different from the first time of day, illuminating, according to the second time of day, the first space via the external light source; and in accordance with a determination that the input corresponds to a third time of day different from the first time of day and the second time of day, illuminating, according to the third time of day, the first space via the external light source.

In some embodiments, a computer system in communication with an external light source and an input device is described. In some embodiments, the computer system in communication with an external light source and an input device comprises one or more processors and memory storing one or more programs configured to be executed by the one or more processors. In some embodiments, the one or more programs includes instructions for: while illuminating, according to a first time of day, a first space via the external light source, detecting, via the input device, an input; and in response to detecting the input: in accordance with a determination that the input corresponds to a second time of day different from the first time of day, illuminating, according to the second time of day, the first space via the external light source; and in accordance with a determination that the input corresponds to a third time of day different from the first time of day and the second time of day, illuminating, according to the third time of day, the first space via the external light source.

In some embodiments, a computer system in communication with an external light source and an input device is described. In some embodiments, the computer system in communication with an external light source and an input device comprises means for performing each of the following steps: while illuminating, according to a first time of day, a first space via the external light source, detecting, via the input device, an input; and in response to detecting the input: in accordance with a determination that the input corresponds to a second time of day different from the first time of day, illuminating, according to the second time of day, the first space via the external light source; and in accordance with a determination that the input corresponds to a third time of day different from the first time of day and the second time of day, illuminating, according to the third time of day, the first space via the external light source.

In some embodiments, a computer program product is described. In some embodiments, the computer program product comprises one or more programs configured to be executed by one or more processors of a computer system in communication with an external light source and an input device. In some embodiments, the one or more programs include instructions for: while illuminating, according to a first time of day, a first space via the external light source, detecting, via the input device, an input; and in response to detecting the input: in accordance with a determination that the input corresponds to a second time of day different from the first time of day, illuminating, according to the second time of day, the first space via the external light source; and in accordance with a determination that the input corresponds to a third time of day different from the first time of day and the second time of day, illuminating, according to the third time of day, the first space via the external light source.

In some embodiments, a method that is performed at a computer system that is in communication with a light source, an input device, and a display generation component is described. In some embodiments, the method comprises: While causing a first environment to be illuminated by the light source, displaying, via the display generation component, a user interface element including: in accordance with a determination that a second environment, different from the first environment, has a first illumination, a first representation of the second environment, wherein the first representation has a first appearance based on the first illumination; and in accordance with a determination that the second environment has a second illumination different from the first illumination, a second representation of the second environment, wherein the second representation has a second appearance based on the second illumination, and wherein the second appearance is different from the first appearance; detecting, via the input device, a first set of one or more inputs, wherein the first set of one or more inputs includes an input corresponding to the user interface element; and in response to detecting the first set of one or more inputs, illuminating, via the light source, the first environment based on illumination of the second environment.

In some embodiments, a non-transitory computer-readable storage medium storing one or more programs configured to be executed by one or more processors of a computer system that is in communication with a light source, an input device, and a display generation component is described. In some embodiments, the one or more programs includes instructions for: While causing a first environment to be illuminated by the light source, displaying, via the display generation component, a user interface element including: in accordance with a determination that a second environment, different from the first environment, has a first illumination, a first representation of the second environment, wherein the first representation has a first appearance based on the first illumination; and in accordance with a determination that the second environment has a second illumination different from the first illumination, a second representation of the second environment, wherein the second representation has a second appearance based on the second illumination, and wherein the second appearance is different from the first appearance; detecting, via the input device, a first set of one or more inputs, wherein the first set of one or more inputs includes an input corresponding to the user interface element; and in response to detecting the first set of one or more inputs, illuminating, via the light source, the first environment based on illumination of the second environment.

In some embodiments, a transitory computer-readable storage medium storing one or more programs configured to be executed by one or more processors of a computer system that is in communication with a light source, an input device, and a display generation component is described. In some embodiments, the one or more programs includes instructions for: While causing a first environment to be illuminated by the light source, displaying, via the display generation component, a user interface element including: in accordance with a determination that a second environment, different from the first environment, has a first illumination, a first representation of the second environment, wherein the first representation has a first appearance based on the first illumination; and in accordance with a determination that the second environment has a second illumination different from the first illumination, a second representation of the second environment, wherein the second representation has a second appearance based on the second illumination, and wherein the second appearance is different from the first appearance; detecting, via the input device, a first set of one or more inputs, wherein the first set of one or more inputs includes an input corresponding to the user interface element; and in response to detecting the first set of one or more inputs, illuminating, via the light source, the first environment based on illumination of the second environment.

In some embodiments, a computer system configured to communicate with a light source, an input device, and a display generation component is described. In some embodiments, the computer system comprises one or more processors and memory storing one or more programs configured to be executed by the one or more processors. In some embodiments, the one or more programs includes instructions for: While causing a first environment to be illuminated by the light source, displaying, via the display generation component, a user interface element including: in accordance with a determination that a second environment, different from the first environment, has a first illumination, a first representation of the second environment, wherein the first representation has a first appearance based on the first illumination; and in accordance with a determination that the second environment has a second illumination different from the first illumination, a second representation of the second environment, wherein the second representation has a second appearance based on the second illumination, and wherein the second appearance is different from the first appearance; detecting, via the input device, a first set of one or more inputs, wherein the first set of one or more inputs includes an input corresponding to the user interface element; and in response to detecting the first set of one or more inputs, illuminating, via the light source, the first environment based on illumination of the second environment.

In some embodiments, a computer system configured to communicate with a light source, an input device, and a display generation component is described. In some embodiments, the computer system comprises means for performing each of the following steps: While causing a first environment to be illuminated by the light source, displaying, via the display generation component, a user interface element including: in accordance with a determination that a second environment, different from the first environment, has a first illumination, a first representation of the second environment, wherein the first representation has a first appearance based on the first illumination; and in accordance with a determination that the second environment has a second illumination different from the first illumination, a second representation of the second environment, wherein the second representation has a second appearance based on the second illumination, and wherein the second appearance is different from the first appearance; detecting, via the input device, a first set of one or more inputs, wherein the first set of one or more inputs includes an input corresponding to the user interface element; and in response to detecting the first set of one or more inputs, illuminating, via the light source, the first environment based on illumination of the second environment.

In some embodiments, a computer program product is described. In some embodiments, the computer program product comprises one or more programs configured to be executed by one or more processors of a computer system that is in communication with a light source, an input device, and a display generation component. In some embodiments, the one or more programs include instructions for: While causing a first environment to be illuminated by the light source, displaying, via the display generation component, a user interface element including: in accordance with a determination that a second environment, different from the first environment, has a first illumination, a first representation of the second environment, wherein the first representation has a first appearance based on the first illumination; and in accordance with a determination that the second environment has a second illumination different from the first illumination, a second representation of the second environment, wherein the second representation has a second appearance based on the second illumination, and wherein the second appearance is different from the first appearance; detecting, via the input device, a first set of one or more inputs, wherein the first set of one or more inputs includes an input corresponding to the user interface element; and in response to detecting the first set of one or more inputs, illuminating, via the light source, the first environment based on illumination of the second environment.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for illuminating a physical space, thereby increasing the effectiveness, efficiency, and user satisfaction with such devices. Such methods and interfaces may complement or replace other methods for illuminating a physical space.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6C illustrate exemplary environments for storing lighting conditions in accordance with some embodiments.

FIG. 7 is a flow diagram illustrating a method for storing lighting conditions in accordance with some embodiments.

FIGS. 8A-8D illustrate exemplary environments for simulating lighting conditions in accordance with some embodiments.

FIG. 9 is a flow diagram illustrating a method for simulating lighting conditions in accordance with some embodiments.

FIG. 10 is a flow diagram illustrating a method for simulating lighting conditions based on a time of day in accordance with some embodiments.

FIGS. 11A-11C illustrate exemplary user interfaces for duplicating lighting conditions in accordance with some embodiments.

FIG. 12 is a flow diagram illustrating a method for duplicating lighting conditions in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for illuminating a physical space. For example, a physical space can be illuminated based one or more preferences of a user. Such techniques can reduce the cognitive burden on a user who desires to illuminate physical spaces, thereby enhancing productivity. Further, such techniques can reduce processor and battery power otherwise wasted on redundant user inputs.

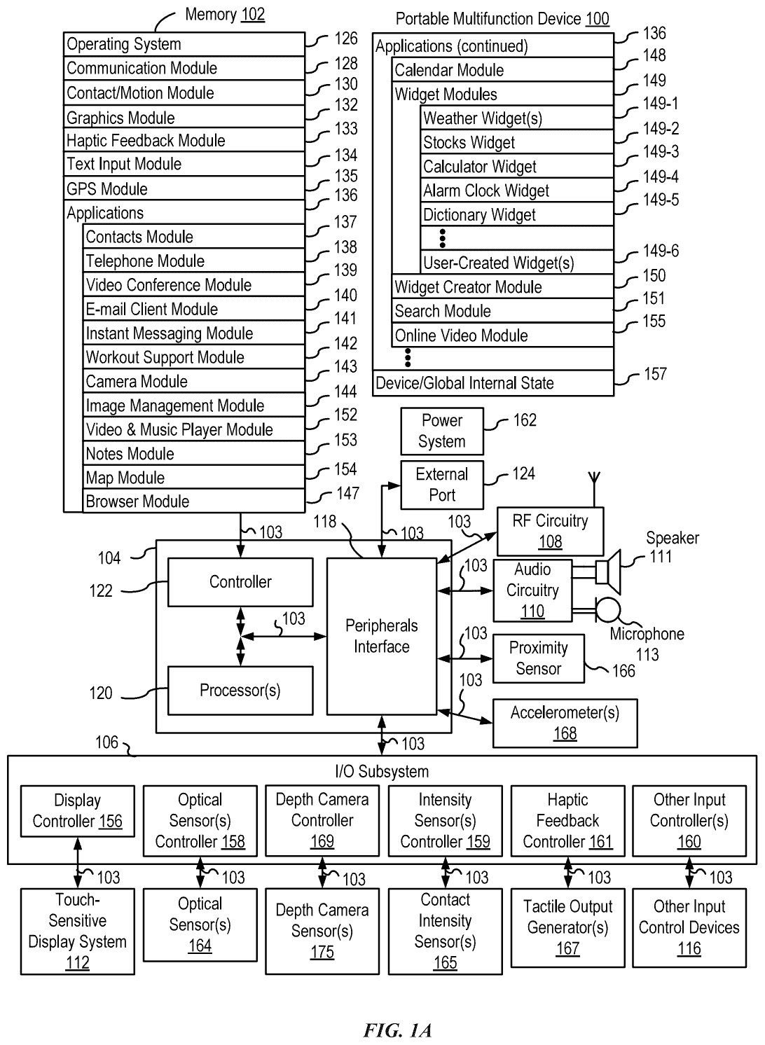

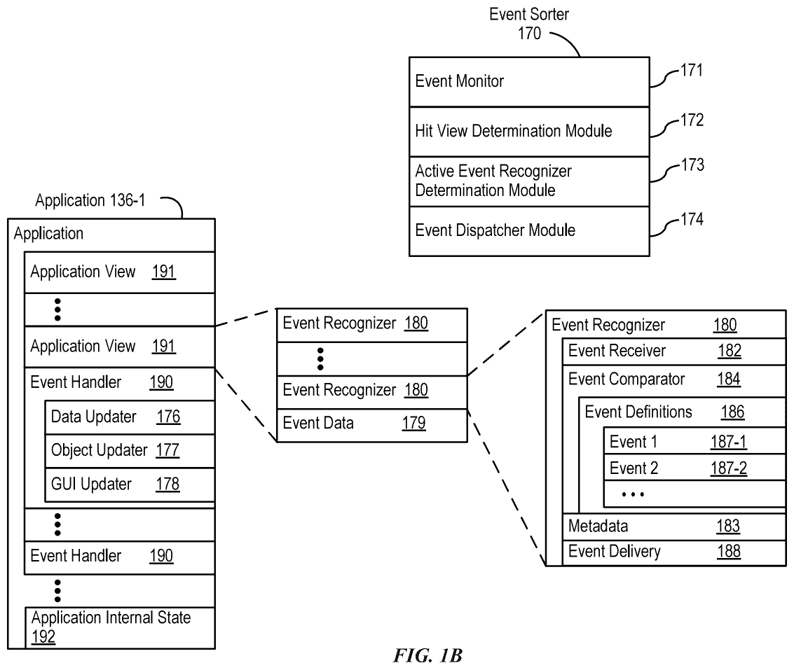

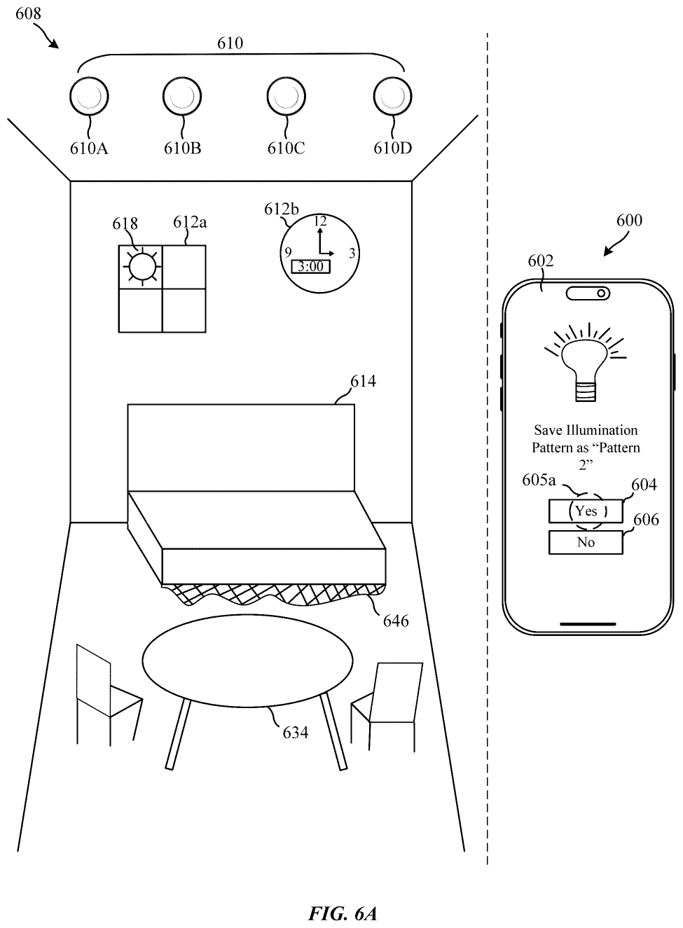

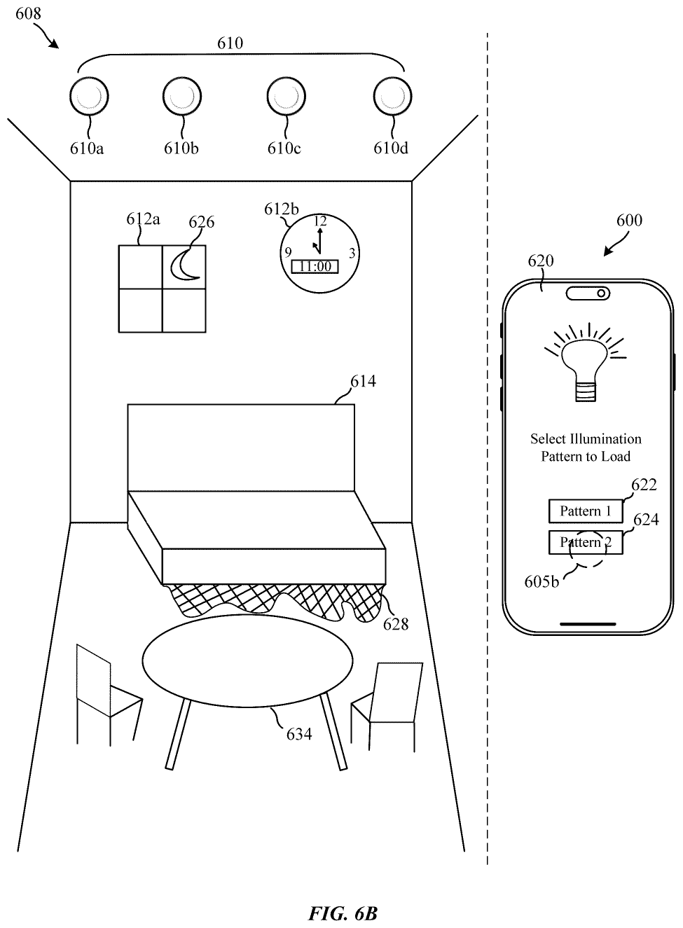

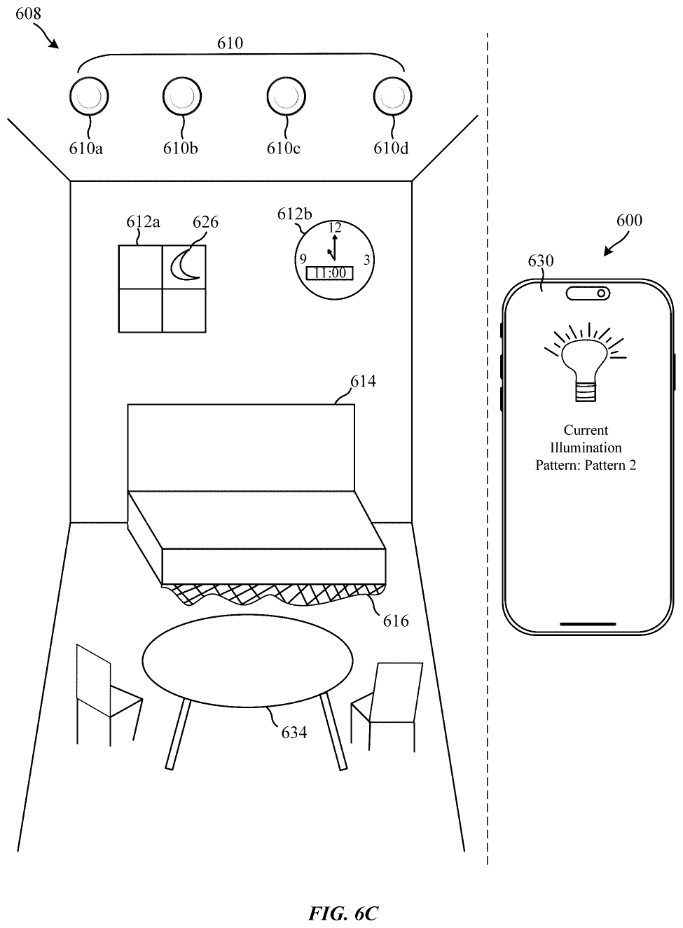

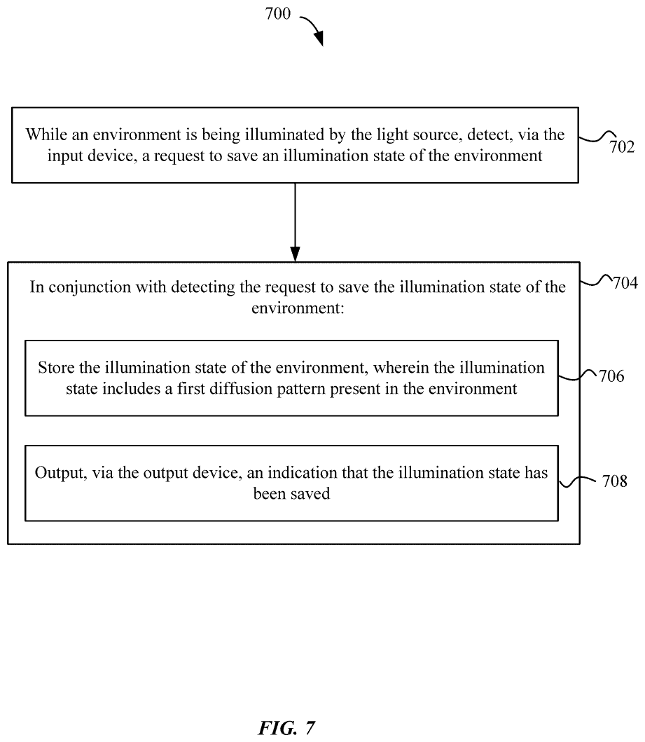

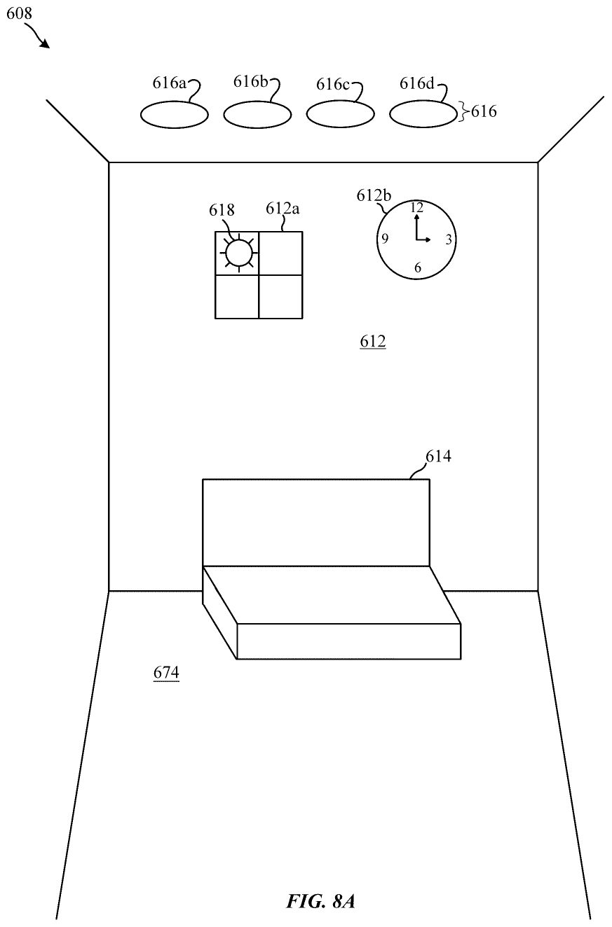

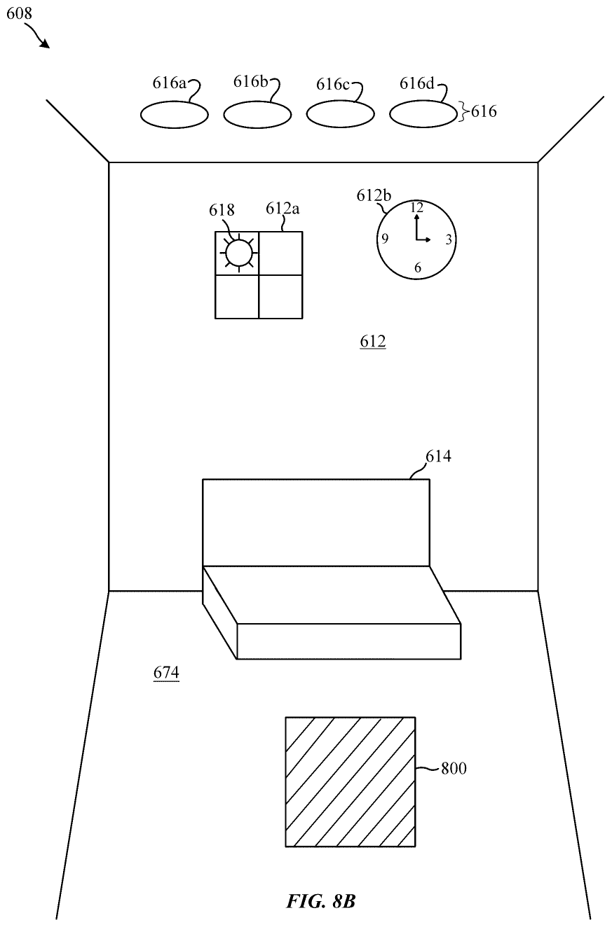

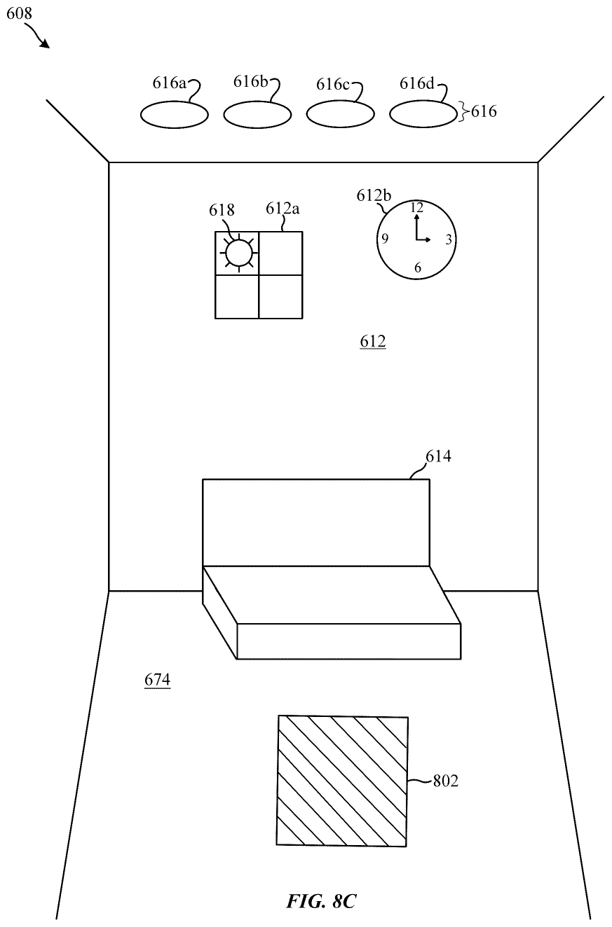

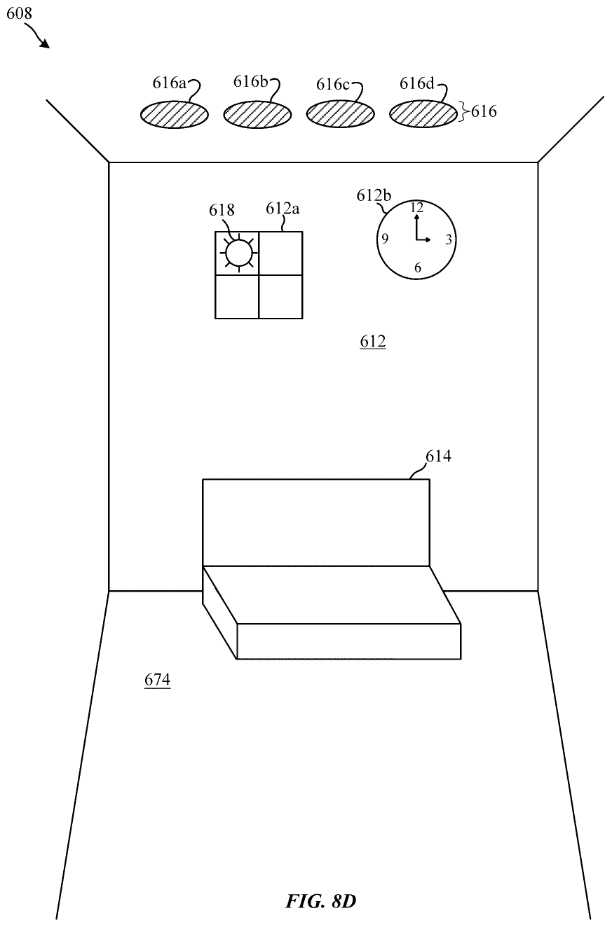

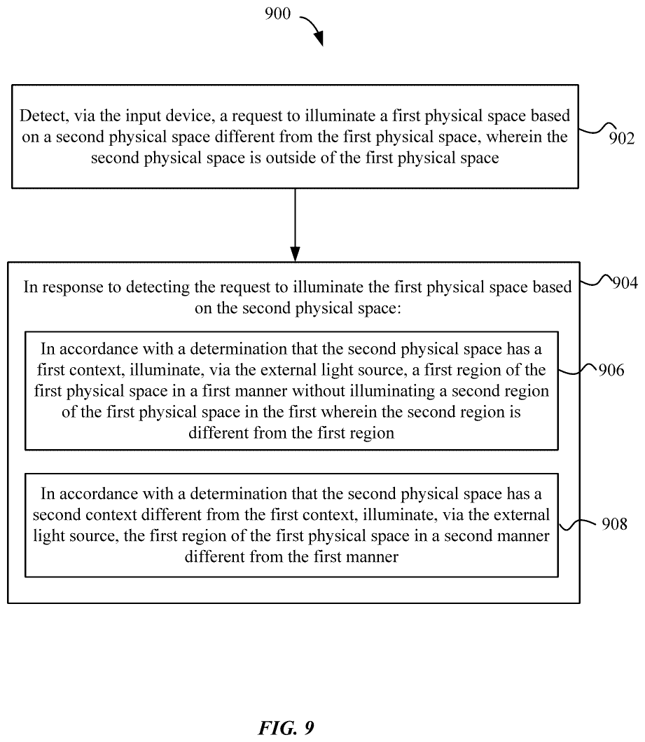

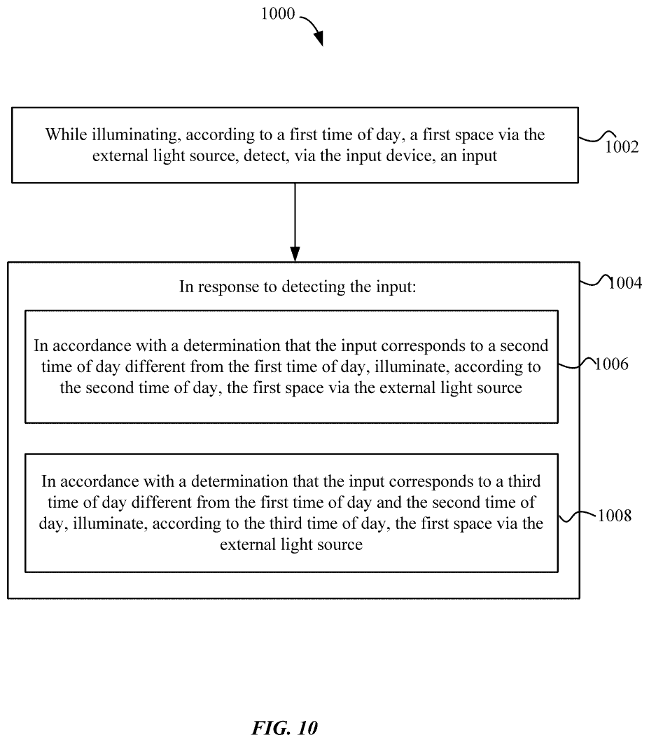

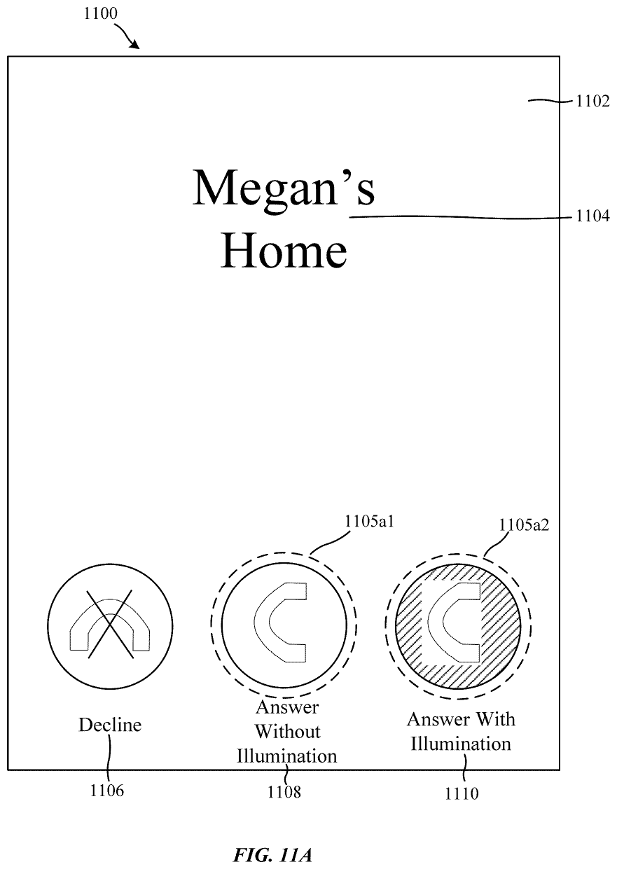

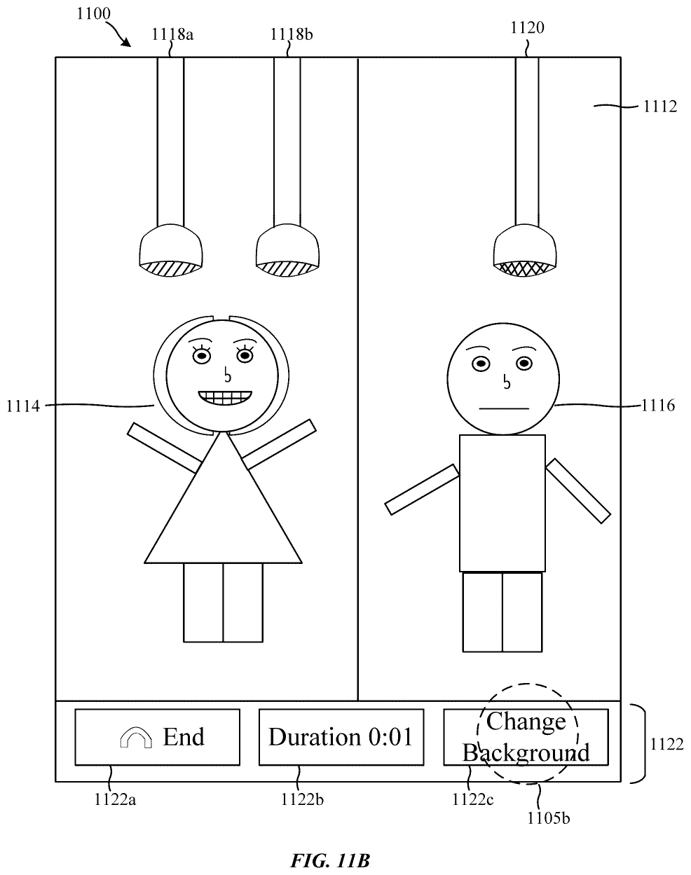

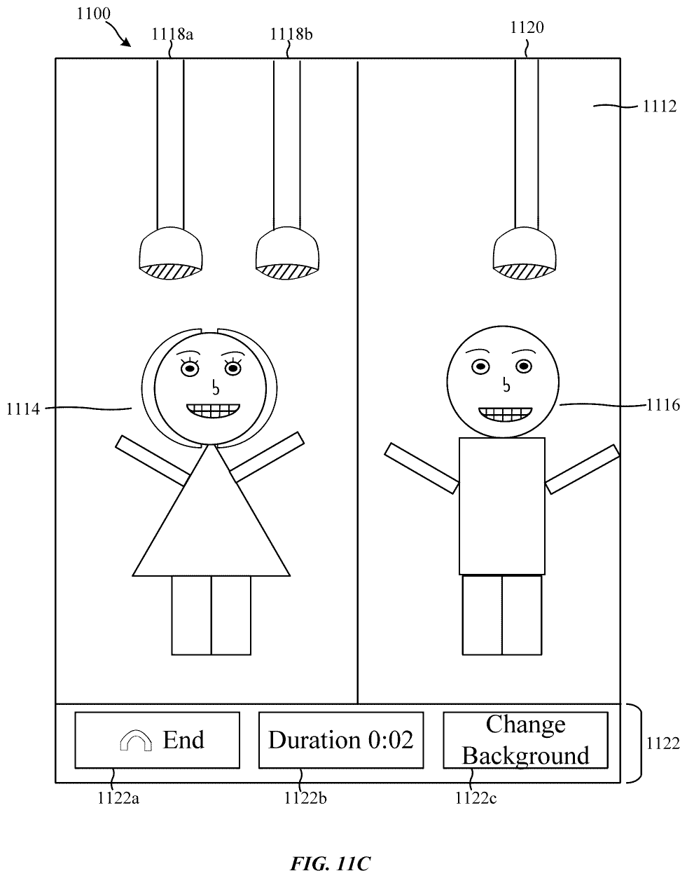

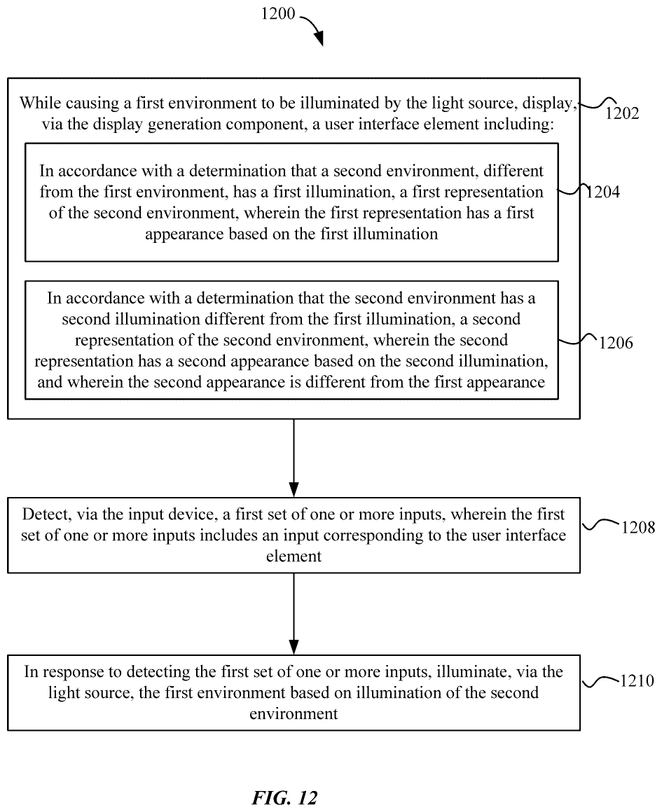

Below, FIGS. 1A-1B, 2, 3, 4A-4B, and 5A-5B provide a description of exemplary devices for performing the techniques for illuminating a physical space. FIGS. 6A-6C illustrate exemplary environments for storing lighting conditions. FIG. 7 is a flow diagram illustrating a method for storing lighting conditions. The environments in FIGS. 6A-6C are used to illustrate the processes described below, including the processes in FIG. 7. FIGS. 8A-8D illustrate exemplary environments for simulating lighting conditions. FIG. 9 is a flow diagram illustrating a method for simulating lighting conditions. FIG. 10 is a flow diagram illustrating a method for simulating lighting conditions based on a time of day. The environments in FIGS. 8A-8D are used to illustrate the processes described below, including the processes in FIG. 9 and FIG. 10. FIGS. 11A-11C illustrate exemplary user interfaces for duplicating lighting conditions. FIG. 12 is a flow diagram illustrating a method for duplicating lighting conditions. The user interfaces in FIGS. 11A-11C are used to illustrate the processes described below, including the processes in FIG. 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

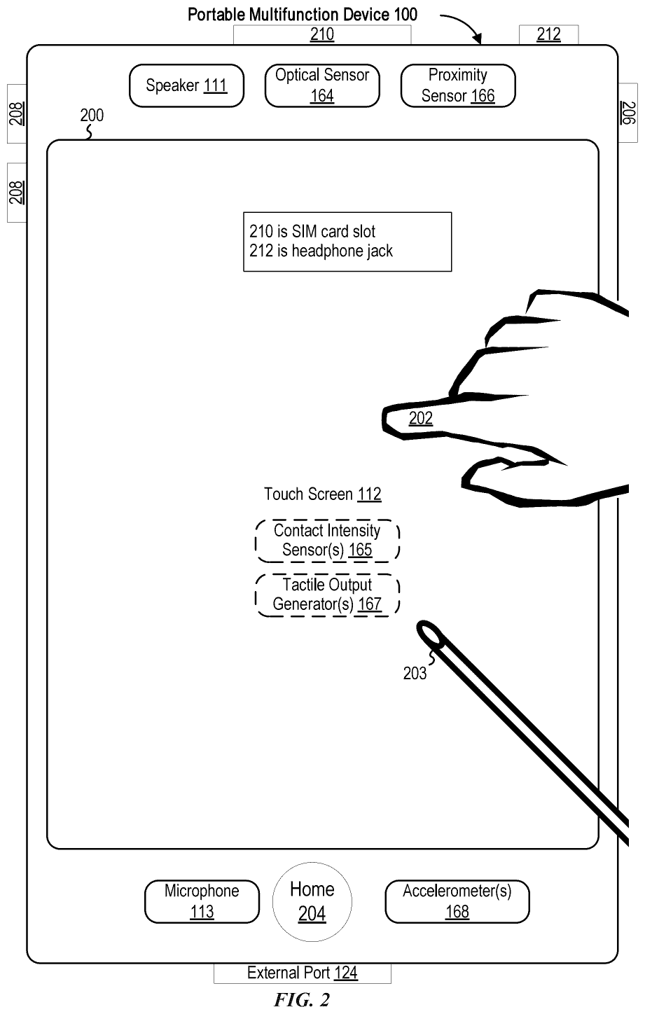

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three-dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three-dimensional” scene and the “255” value represents pixels that are located closest to a viewpoint (e.g., a camera, an optical sensor, a depth camera sensor) in the “three-dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods and Apparatuses for Operating a Portable Device Based on an Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

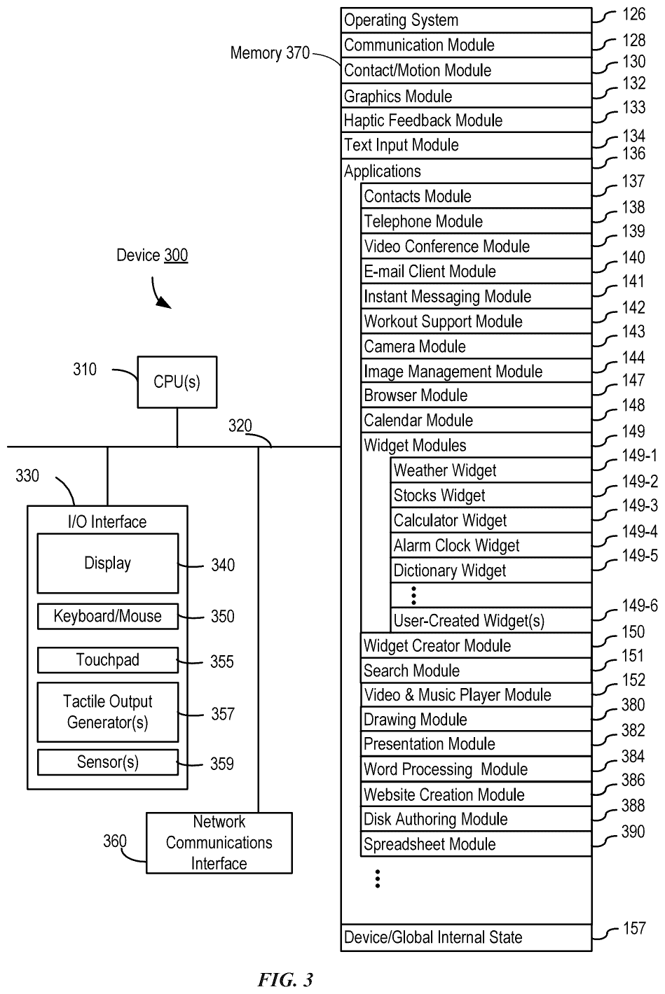

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds is determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the sets of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137 or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100.

Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

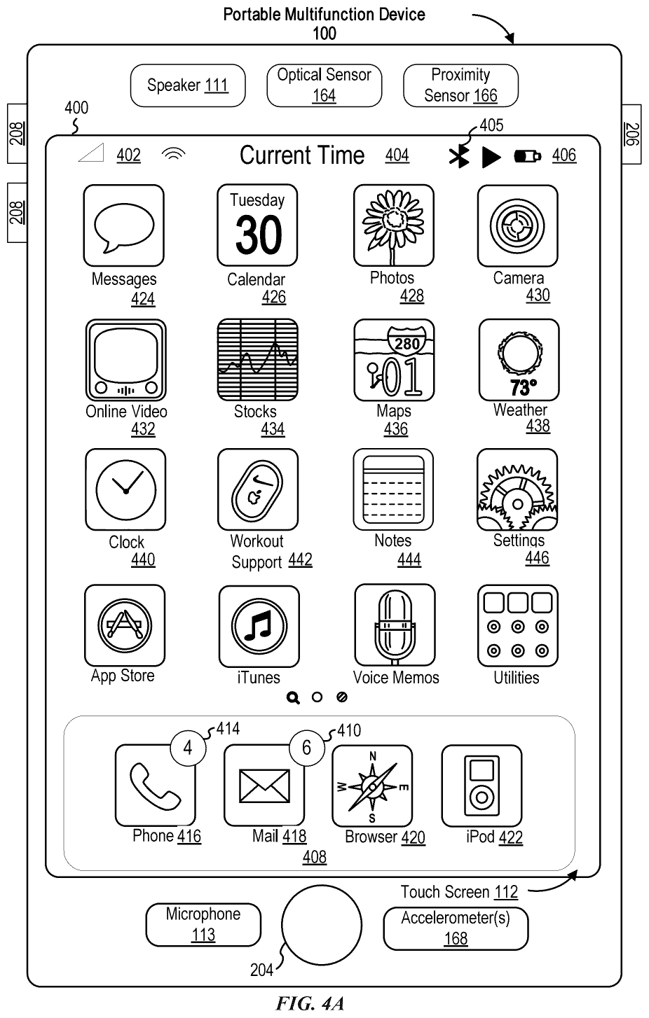

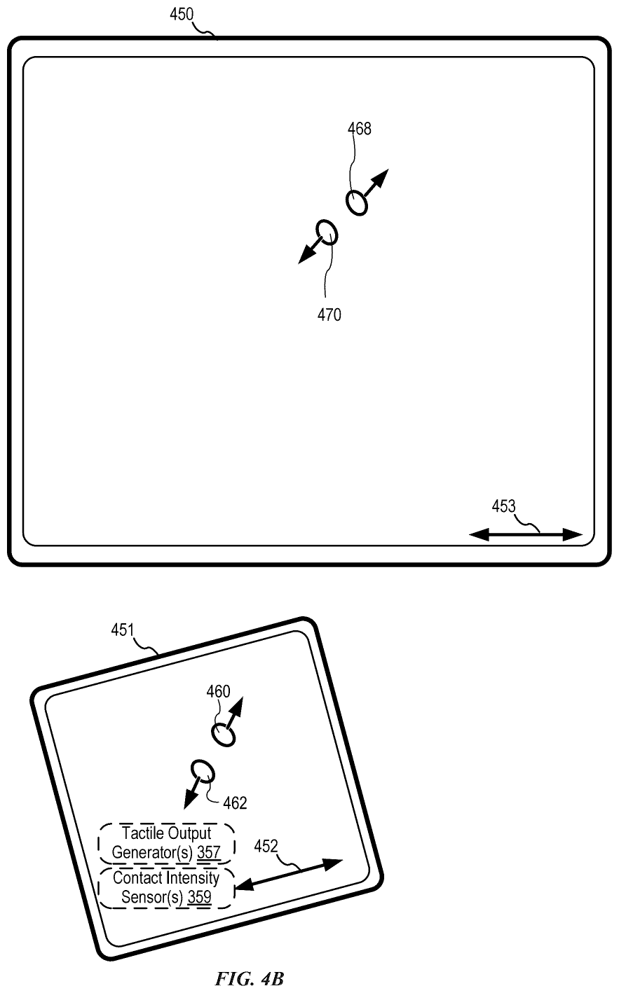

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

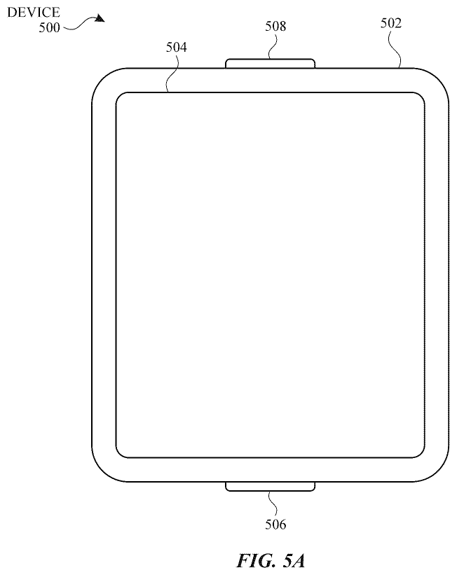

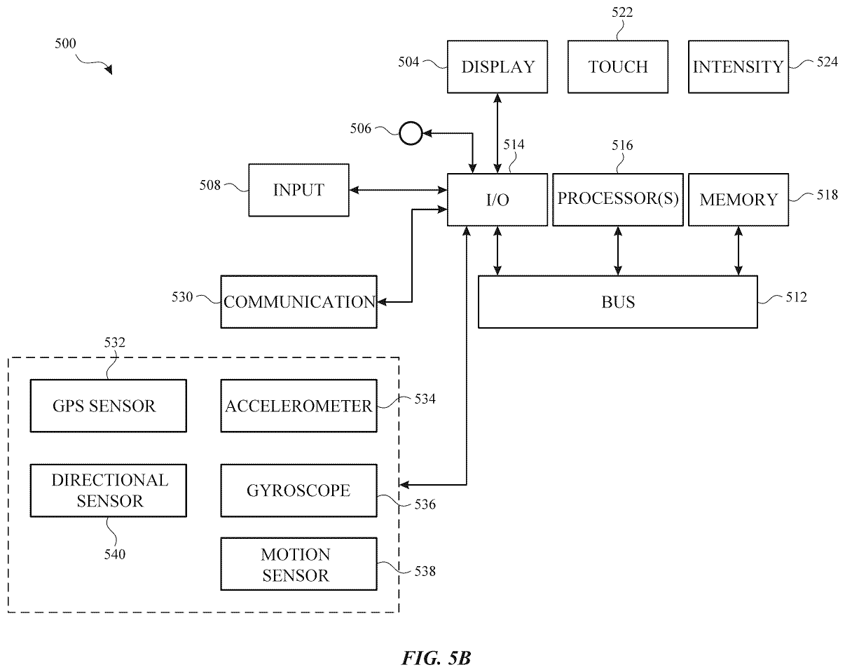

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, 1000, and 1200 (FIGS. 7, 9, 10, and 12). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6C illustrate exemplary environments for storing lighting conditions in accordance with some embodiments. The environments in these figures are used to illustrate the processes described below, including the processes in FIG. 7.

FIG. 6A illustrates physical space 608, a room in a house. Physical space 608 includes multiple light sources 610A, 610B, 610C, and 610D (collectively referred to hereinafter as light sources 610) that illuminate physical space 608. It should be recognized that more or fewer light sources can be included in light sources 610 (including only one light source) and the set of light sources can be arranged in any physical arrangement. In some embodiments, there is no physical restriction on physical placement, separation, orientation, and/or number of light sources. In some embodiments, each light source of light sources 610 has a separate housing (e.g., as illustrated by 610A, 610B, 610C, and 610D). In other examples, one or more light sources of light sources 610 share a common housing (e.g., a single light fixture for light source 610A, light source 610B, light source 610C, and light source 610D). In some embodiments, light sources 610 include one or more features as described herein with respect to any one or more light sources described with respect to FIGS. 8 and/or 11. In some embodiments, physical space 608 is a physical space of an area in another type of building, such as a hotel, an office, and/or a school.

In some embodiments, a light source (e.g., 610A, 610B, 610C, and/or 610D) includes one or more features of portable multifunction device 100, device 300, and/or device 500. For example, a light source can include and/or be in communication with one or more processors and memory that are used to store and/or execute one or more instructions for performing the processes described herein. In some embodiments, one or more processors cause one or more light sources (e.g., 610) to perform operations (e.g., detect the input, illuminate a region, and/or determine properties of a physical space). In some embodiments, the one or more processors are in communication with one or more light sources (e.g., 610). In some embodiments, the one or more processors are separate from one or more light sources (e.g., 610).

In some embodiments, light sources 610 are in communication with one or more other devices (e.g., computer systems). For example, light sources 610 can communicate with one or more sensor devices (e.g., that sense one or more properties of a physical space (e.g., physical space 608) and/or an environment). For another example, light sources 610 can communicate with one or more processing devices (e.g., that process sensor data, determine illumination levels, and/or process inputs that assist and/or instruct light sources 610 to output illumination as described in the examples described herein). It should be recognized that one or more of the operations described below are performed by a device different from light sources 610, such as a personal computing device (e.g., a phone, a tablet, a laptop, a desktop, and/or a wearable device) or a communal device (e.g., a smart speaker, a television, a router, and/or a hub). Unless otherwise noted explicitly, this description should not be construed as limiting the scope of such operations to be performed by a single device (e.g., light sources 610) or a particular combination of devices.

As illustrated in FIG. 6A, physical space 608 includes several physical features (e.g., physical object and/or physical structures) that are physically present in the room and/or that form a part of the room. Such physical features include clock 612b, couch 614, window 612a, and table 634—each being physical features that make up and/or are in included in physical space 608 (e.g., define boundaries of and/or are present in physical space 608).

As mentioned above, light sources 610 can be used to intelligently illuminate physical space 608. In some embodiments, light sources 610 provide illumination based on one or more properties (e.g., of physical features) of physical space 608. In some embodiments, light sources 610 provide illumination in response to a request (e.g., in response to detecting input, such as user input). In some embodiments, light sources 610 provide illumination automatically (e.g., without detecting input, such as user input) (e.g., intelligently lights physical space 608 and/or a portion thereof (e.g., a region)) based on one or more properties of physical space 608. In some embodiments, a property of physical space 608 includes a physical feature of physical space 608, physical properties of the physical feature (e.g., location, pose, color, material, reflectivity, and/or opacity), and/or a context of physical space 608 (e.g., events occurring within physical space 608, user activity, weather, and/or time of day). The examples provided of properties are not intended to be exhaustive, but merely illustrative. Other examples described herein are intended to be inclusive with those listed above.

In some embodiments, light sources 610 provide illumination of a region of physical space 608 based on one or more properties of the region. In such examples, the region of physical space 608 can be a portion (e.g., less than all and/or a subset of), an area, and/or a volume of physical space 608.

The present disclosure relates to saving various diffusion patterns that are present within physical space 608 (e.g., naturally present and/or artificially present). The diffusion patterns of physical space 608 are created by natural light present within physical space 608 (e.g., natural light from the sun and/or the moon) and/or artificial light (e.g., light from light sources 610). Diffusion patterns are saved on a user's computer system (e.g., smartphone, tablet, speaker, television) and/or on a server (e.g., a server that is in communication with the computer system and/or with light sources 610). In some embodiments, light sources 610 are configured to illuminate physical space 608 in various ways at different times throughout a day. The methods of light sources 610 illuminating physical space 608 are discussed in greater detail below.

FIGS. 6A-6C include a left portion and a right portion. The left portion and the right portion of FIGS. 6A-6C are separated by a dashed line. The left portion of FIGS. 6A-6C illustrates physical space 608, as discussed above. The right portion of FIGS. 6A-6C illustrates computer system 600. At FIGS. 6A-6C, computer system 600 is a personal computing device (e.g., a smartphone and/or tablet). However, this is merely exemplary, and it should be understood that, in some embodiments, computer system 600 is a different type of computer system (e.g., television, desktop computer, head-mounted computer system (e.g., augmented reality and/or virtual reality computer system), fitness tracker, and/or laptop). Through the detection of user inputs and/or various predefined configurations and/or settings, computer system 600 controls the operations of light sources 610.

The left portion of FIG. 6A illustrates physical space 608, which includes light sources 610A-D on the ceiling of physical space 608, as well as window 612a and clock 612b on the wall of physical space 608. FIG. 6A illustrates sun 618 outside window 612a and illustrates clock 612b as reading 3:00 PM. Accordingly, at FIG. 6A, the current time of day is 3:00 PM. FIG. 6A also illustrates objects within physical space 608, such as couch 614 and table 634.

At FIG. 6A, the light within physical space 608 causes a shadow to form in the shape of shadow pattern 646 in front of couch 614. The formation of shadow pattern 646 is created as a result of how light from light sources 610 and sun 618 illuminate physical space 608. The result of light sources 610 and sun 618 illuminating physical space 608 at FIG. 6A is hereinafter referred to as the “second diffusion pattern.” In some embodiments, the illumination from light sources 610 at FIG. 6A is based on the detection of a user making a verbal request for light sources 610 to output light in a specific way (e.g., with a certain level of brightness, directionality, color, hue, warmth, and/or intensity). In some embodiments, the illumination from light sources 610 is based on a predefined user configuration that was previously recorded (e.g., on computer system 600 and/or on a computer system that is external to computer system 600). For example, at 3:00 PM a predefined user configuration can cause light source 610A and light source 610b to be powered on while at 8:00 PM a separate predefined user configuration can cause all the light sources included in light sources 610 to be powered on.

The right side of FIG. 6A illustrates computer system 600 displaying user interface 602. As illustrated at FIG. 6A, user interface 602 includes a prompt asking the user whether the current diffusion pattern of physical space 608 (e.g., the second diffusion pattern) should be saved. User interface 602 displays option 604 (e.g., “Yes”) and option 606 (e.g., “No”), which provide options to save or not save the second diffusion pattern of physical space 608. At FIG. 6A, computer system 600 detects input 605a on option 604 (e.g., “Yes”). In some embodiments, computer system 600 displays user interface 602 automatically (e.g., without intervening user input) upon the detection that the user has entered an environment (e.g., physical space 608). In some embodiments, computer system 600 displays user interface 602 in response to detecting one or more user inputs.

Between FIG. 6A and FIG. 6B, in response to detecting input 605a, computer system 600 saves the second diffusion pattern (e.g., on computer system 600 and/or on a computer system that is external to computer system 600). One or more various characteristics (e.g., amount of light, brightness of light, color characteristics (e.g., color, hue, tone and/or warmth) of light) are stored as part of saving the second diffusion pattern. Computer system 600 outputs an indication that the second diffusion pattern was successfully saved once the second diffusion pattern has been saved. In some embodiments, the indication includes both a textual component (e.g., “The second diffusion pattern has been saved” and/or “Second diffusion pattern is saved”) and/or a graphical component (e.g., a representation of physical space 608 and/or a representation of the second diffusion pattern). In some embodiments, computer system 600 outputs an audio output, visual output, and/or haptic output as part of outputting the indication that the second diffusion pattern was successfully saved. In some embodiments, computer system 600 temporarily displays a banner (e.g., a graphical element along the top of the display of computer system 600) as part of outputting the indication that the second diffusion pattern was successfully saved. In some embodiments, multiple different diffusion patterns are stored at one point in time. In some embodiments, diffusion patterns are automatically saved (e.g., without intervening user input) based on a determination that lighting conditions (e.g., natural lighting conditions and/or artificial lighting conditions) within physical space 608 have changed. In some embodiments, in response to detecting input 605a, computer system 600 causes light sources 610 to change the lighting within physical space 608 such that physical space 608 no longer has the second diffusion pattern.

FIG. 6B illustrates clock 612b as reading 11:00, which indicates that 8 hours have passed between FIGS. 6A and 6B. As illustrated in FIG. 6B, moon 626 is outside of window 612a, indicating that it is currently the evening time. At FIG. 6B, the light from moon 626 and the light from light sources 610 cause a third diffusion pattern (e.g., that is different and/or distinct from the second diffusion pattern) to be present within physical space 608. At FIG. 6B, because the third diffusion pattern is present within physical space 608, shadow pattern 628, which is a different pattern than shadow pattern 646 as illustrated in FIG. 6A, extends from the front of couch 614. The difference in diffusion patterns from FIG. 6A to FIG. 6B is due to the difference in lighting conditions within physical space 608 between FIG. 6A and FIG. 6B. That is, shadow pattern 628 is formed at 11:00 PM when there is no sunlight present within physical space 608 and moonlight is present within physical space 608. That is, the combination of light sources 610 and sunlight creates a different diffusion pattern within physical space 608 than the combination of light from moon 626 and light sources 610. In some embodiments, the difference between the second diffusion pattern and the third diffusion pattern is caused by the artificial light (e.g., light from light sources 610) within physical space 608. In some embodiments, the user configures computer system 600 and/or light sources 610 to track the levels of natural light (e.g., sunlight and moonlight) throughout the day. For example, computer system 600 can track the amount of natural light, brightness of natural light, and/or source of natural light within physical space 608 at different times during the day. In some embodiments, the operation of light sources 610 is adjusted (e.g., automatically adjusted) based on the amount of natural light that is detected to be present in physical space 608. In some embodiments, the change in the diffusion pattern within physical space 608 throughout the day is based on the user's configuration (e.g., via computer system 600) of light sources 610 to output varying levels of light throughout the day (e.g., dynamic configuration) and not based on an amount of natural light present within physical space 608. In some embodiments, computer system 600 saves the third diffusion pattern automatically (e.g., without intervening user input). For example, computer system 600 can be configured to automatically save respective diffusion patterns that are present in physical space 608 on an hourly basis. As discussed in greater detail below, computer system 600 can cause light sources 610 to simulate a saved diffusion pattern. That is, light sources 610 can simulate the third diffusion pattern at a respective point in time when moon 626 is not within window 612a. This process will be illustrated and discussed in greater detail below at FIG. 6C.

In some embodiments, between FIG. 6A to FIG. 6B, the operation of light sources 610 automatically changes such that the diffusion pattern within physical space 608 changes. That is, in some embodiments, it is not necessary for computer system 600 to detect a respective input for light sources 610 to dynamically alter the diffusion pattern within physical spacc 608 based on changes to the natural light within physical space 608. For example, based on a determination that the natural light within physical space 608 decreases, light sources 610 automatically (e.g., without intervening user input) increases its output of illumination.

As illustrated in FIG. 6B, computer system 600 displays user interface 620. User interface 620 includes a prompt which asks the user to select the diffusion pattern with which the user would like to illuminate physical space 608. Further, as illustrated in FIG. 6B, user interface 620 includes option 622 and option 624. Option 622 corresponds to a first diffusion pattern that has been saved and option 624 corresponds to the second diffusion pattern that has been saved (e.g., as discussed above in reference to FIG. 6A). At FIG. 6B, computer system 600 detects input 605b that corresponds to selection of option 624 (e.g., “Diffusion Pattern 2”). In some embodiments, input 605b is a voice command (“Make the lights how I had them at 3 PM” or “Go back to what I saved earlier.”), gaze input, rotation of a rotatable input mechanism, swipe input, and/or air gesture.

As illustrated in FIG. 6C, in response to detecting input 605b, computer system 600 displays user interface 630, which indicates that the current diffusion pattern within physical space 608 is Pattern 2 (which is the diffusion pattern within physical space 608 at FIG. 6A). At FIG. 6C, clock 612b reads 11:00 PM indicating that less than a minute has passed between FIG. 6B to FIG. 6C. That is, though FIG. 6B and FIG. 6C occur at almost the identical times, physical space 608 is illuminated with a different diffusion pattern (e.g., in contrast to the diffusion pattern of physical space 608 at FIG. 6B) that mimics the diffusion pattern present in the room at 3:00 PM.

At FIG. 6C, at nighttime, light sources 610 produce light in such a way that replicates the second diffusion pattern that is created by the combination of natural light sources (e.g., sunlight or moon light) and light from light sources 610. Simulating the second diffusion pattern requires that light sources 610 compensate for changes to the natural lighting within physical space 608. For example, at FIG. 6C, the brightness of the natural light is less than the brightness of the natural light at FIG. 6A. This causes light sources 610 to output brighter light (e.g., in comparison to the brightness of the light output by light sources 610 at FIG. 6A) to compensate for the decrease in the brightness of the natural light. In some examples, light sources 610 output light with identical characteristics (e.g., color, hue, tone, brightness and/or warmth) as the stored diffusion patterns. For example, as discussed above, various characteristics of the light of the second diffusion pattern are saved as part of storing the second diffusion pattern. Light sources 610 output light with the stored various characteristics of the second diffusion pattern as part of simulating the second diffusion pattern. In some embodiments, one or more characteristics (e.g., brightness, color, and/or warmth) of naturally occurring light are at the same level during the day as it is at night. For example, if the sunlight during the day is dim due to cloud coverage but the moonlight at night is bright due to clear skies, the brightness of the natural light that comes through window 612a may be at the same level at night as during the day. Therefore, the level of brightness that light sources 610 output while simulating the second diffusion pattern is the same level of brightness irrespective of if light sources 610 simulate the second diffusion pattern during the night or during the day.

In some embodiments, the operation of one or more of light sources 610A, 610B, 610C, and 610D is not synchronized. That is, each light outputs different characteristics of light (e.g., of color, hue, tone, brightness, and/or warmth) at different times. For example, light source 610A can output a bright, warm light while light source 610B flashes in a strobe-like manner while light 610C outputs a dim, cool light.

In some embodiments, the diffusion patterns illustrated in FIGS. 6A-6C are output within an environment different than physical space 608. For example, if the user walks with computer system 600 to a different room, the user can configure computer system 600 to output the second diffusion pattern in the different room. It should be noted that, even though couch 614 is not present in the different room, the lights in the different room will still produce shadow pattern 628 to match the second diffusion pattern as illustrated in and described with respect to FIG. 6B. In some embodiments, the diffusion pattern that the user saves in physical space 608 is influenced by shadows from cloud coverage in the exterior of physical space 608. When the user moves to a room different than physical space 608 and configures computer system 600 to output the diffusion pattern that was influenced by cloud coverage, the lights in the different room will produce the same diffusion pattern that simulates cloud coverage, even though the diffusion pattern is not naturally present in the different room.

FIG. 7 is a flow diagram illustrating a method (e.g., method 700) for storing lighting conditions in accordance with some embodiments. Some operations in method 700 are, optionally, combined, the orders of some operations are, optionally, changed, and some operations are, optionally, omitted.

As described below, method 700 provides an intuitive way for storing lighting conditions. Method 700 reduces the cognitive burden on a user, thereby creating a more efficient human-machine interface. For battery-operated computing devices, enabling a user to store lighting conditions faster and more efficiently conserves power and increases the time between battery charges.

In some embodiments, method 700 is performed at a computer system (e.g., 600) that is in communication with a light source (e.g., 610a-610d, 616a-616d, 610, and/or 616) (e.g., an illumination device, a point light source, a spotlight, and/or one or more light sources), an input device (e.g., a camera, a depth sensor, a microphone, a hardware input mechanism, a rotatable input mechanism, a heart monitor, a temperature sensor, and/or a touch-sensitive surface), and an output device (e.g., display generation component (e.g., a display screen, a projector, and/or a touch-sensitive display), a speaker, and/or a haptic output device). In some embodiments, the computer system is a phone, a watch, a tablet, a fitness tracking device, a wearable device, an accessory, a speaker, a light, a head-mounted display (HMD), and/or a personal computing device. In some embodiments, the light source is not physically connected to and/or coupled to the computer system.

While an environment (e.g., a physical environment and/or a mixed-reality environment) is being illuminated by the light source (e.g., 610a-610d, 616a-616d, 610, and/or 616), the computer system (e.g., 600) detects (702), via the input device, a request to save (and/or store) an illumination state (e.g., a lighting state) of the environment. In some embodiments, detecting the request includes detecting an input (e.g., a tap gesture, a long press gesture, a verbal request and/or command, a physical button press, a pointing input and/or air gesture, and/or a rotation of a physical input mechanism) corresponding to the request. In some embodiments, detecting the request includes receiving a message from another computer system, the message indicating that the request was received by the other computer system.

In conjunction with (704) (e.g., before, while, in response to, and/or after) detecting the request to save the illumination state of the environment, the computer system (e.g., 600) stores (706) the illumination state of the environment, wherein the illumination state includes a first diffusion pattern present in the environment (e.g., how light falls through the environment, the shape of lighting and/or shadows present in the environment, and/or how light is dispersed through the environment over a period of time (e.g., 1-60 mins)) (e.g., as a result of and/or at least as a result including the environment being illuminated by the light source (and, in some embodiments, in combination with one or more natural light sources, such as the sun, and/or obstructions, such as a tree and/or a car blocking a portion of sun light)). In some embodiments, the illumination state of the environment is stored in response to detecting the request to save the illumination state of the environment. In some embodiments, the period of time that the saved illumination state is stored and saved is specified by the user (e.g., 1-60 mins).

In conjunction with (704) detecting the request to save the illumination state of the environment, the computer system (e.g., 600) outputs (708), via the output device, an indication (e.g., a graphical indication, text, a numeric indication, an icon that includes an identifier and/or a graphical illustration corresponding to the first diffusion pattern) (e.g., an audio indication, a visual indication, and/or a haptic indication) that the illumination state has been saved. In some embodiments, the first diffusion pattern is not defined but rather depends on one or more objects in the environment. In some embodiments, the indication is output in response to and/or after storing the illumination state of the environment. Outputting an indication that the illumination has been saved in conjunction with detecting the request to save the illumination state of the environment allows the computer system to provide an indication to a user that the illumination state was successfully stored, thereby providing improved feedback. Storing the illumination state of the environment that includes the first diffusion pattern present in the environment configures the computer system to cause the illumination of the environment based on the first diffusion pattern at a point in time where the first diffusion pattern is not naturally present in the environment, thereby reducing the number of inputs needed to perform an operation,

In some embodiments, after storing the illumination state of the environment (e.g., or while or in response to storing the illumination state), the computer system (e.g., 600) illuminates, via the light source (e.g., 610a-610d, 616a-616d, 610, and/or 616), the environment with a second diffusion pattern different from the first diffusion pattern (and not the first diffusion pattern). In some embodiments, while illuminating the environment with the second diffusion pattern, the computer system detects a request (e.g., a swipe input, tap input, voice command, gaze, voice command, and/or air hand gesture) to change the illumination of the environment. In some embodiments, detecting the request to change the illumination of the environment includes detecting a request that is directed to the indication that the illumination state has been saved and/or an icon and/or representation that corresponds to the illumination state. In some embodiments, in response to detecting the request to change the illumination of the environment, the computer system illuminates, via the light source, the environment with (e.g., based on and/or according to) the first diffusion pattern (e.g., and not the second diffusion pattern). In some embodiments, the environment is automatically (e.g., without intervening user input) illuminated with the second diffusion pattern after the illumination state of the environment is stored. In some embodiments, the environment is illuminated with the second diffusion pattern in response to detecting an input (e.g., user input and/or another type of input). In some embodiments, the second diffusion pattern is not defined but rather depends on one or more objects in the environment. Illuminating the environment with the first diffusion pattern in response to detecting the request to change the illumination of the environment while illuminating the environment with the second diffusion pattern allows the computer system to artificially recreate the lighting conditions of the environment at a point in time when the lighting conditions are not naturally occurring in the environment, thereby providing improved feedback and performing an operation when a set of conditions has been met without requiring further user input.

In some embodiments, the request to change the illumination of the environment includes a first request (e.g., an audible request and/or a selection of a user interface object that is displayed (e.g., displayed by the computer system and/or displayed by an external display)) to illuminate the environment with (e.g., based on and/or according to) the first diffusion pattern (e.g., go back to 5 AM or go back to what I stored).

In some embodiments, in accordance with a determination that the environment is being illuminated with (e.g., based on and/or according to) the first diffusion pattern at a first point in time (e.g., the morning, the afternoon, and/or the evening), the illumination state of the environment has a first set of characteristics (e.g., color, hue, tone, brightness, intensity, and/or frequency of pulsating). In some embodiments, in accordance with a determination that the environment is being illuminated with (e.g., based on and/or according to) the first diffusion pattern at a second point in time (e.g., the morning, the afternoon, and/or the evening) different from the first point in time (e.g., the second point in time is before or after the first point in time), the illumination state of the environment has a second set of characteristics (e.g., color, hue, tone, brightness, intensity, and/or frequency of pulsating) different from the first set of characteristics. In some embodiments, the illumination state of the environment transitions from having the first set of characteristics to having the second set of characteristics based on the time transitioning from the first point in time to the third point in time. In some embodiments, a characteristic of the illumination is the same irrespective of whether the illumination has the first set of characteristics or the second set of characteristics. In some embodiments, no characteristic of the illumination is the same when the illumination has the first set of characteristics versus when the illumination has the second set of characteristics. In some embodiments, during a first period of time while illuminating, via the light source (e.g., 610a-610d, 616a-616d, 610, and/or 616), the environment to have the first diffusion pattern, the computer system (e.g., 600) causes the light source to output light with a first amount of illumination; and during a second period of time, different from (e.g., before or after) the first period of time, while illuminating, via the light source, the environment to have the first diffusion pattern, the computer system causes the light source to output light a second amount of illumination different from the first amount of illumination. In some embodiments, the illumination state of the environment occurs and/or is saved over a period of time (e.g., 1-60 mins of diffusion of light in an environment). Selectively illuminating the environment with a set of characteristics when a set of prescribed conditions is met (e.g., the environment is being illuminated at a first point in time or a second point of time) automatically allows the computer system the ability to provide an indication of the current time, thereby performing an operation when a set of conditions has been met without requiring further user input.

In some embodiments, in accordance with a determination that the environment is illuminated with (e.g., based on, according to) the first diffusion pattern at a third point in time (e.g., the morning, the afternoon, and/or the evening), the illumination state of the environment has a third set of characteristics (e.g., color, hue, tone, brightness, intensity, and/or frequency of pulsating). In some embodiments, in accordance with a determination that the environment is being illuminated with (e.g., based on, according to) the first diffusion pattern at a fourth point in time (e.g., the morning, the afternoon, and/or the evening) different from the third point in time (e.g., the third point in time occurs before or after the fourth period of time), the illumination state of the environment has the third set of characteristics. Maintaining the set of characteristics of the illumination state of the environment irrespective of the time at which the environment is illuminated with the first diffusion pattern automatically allows the computer system (e.g., 600) to consistently illuminate the environment with the same lighting conditions throughout various times of the day, thereby performing an operation when a set of conditions has been met without requiring further user input.

In some embodiments, the illumination state includes a color characteristic (e.g., color, hue, tone, and/or warmth) present in the environment (and, in some embodiments, as a result of the environment being illuminated by the light source (e.g., 610a-610d, 616a-616d, 610, and/or 616)). In some embodiments, the illumination state includes a color characteristic present in the environment as a result of the environment being illuminated by the light source and an external light source. Storing a color characteristic of the environment allows the computer system to simulate the colors present in the environment when the illumination state of the environment was stored at a point in time when the color is not naturally present within the environment, thereby improving the feedback and/or reducing the number of inputs needed to perform an operation.

In some embodiments, the illumination state includes a brightness characteristic (e.g., an amount of brightness, whether the brightness in the environment exceeds a brightness threshold, and/or whether the brightness in the environment is less than a threshold) present in the environment. In some embodiments, the illumination state includes the brightness characteristic as a result of the environment being illuminated by the light source (e.g., 610a-610d, 616a-616d, 610, and/or 616). In some embodiments, the illumination state includes a brightness characteristic present in the environment as a result of the environment being illuminated by the light source and an external light source (e.g., a light source different from the light source). In some embodiments, the brightness characteristic is present in the environment as a result of the environment being illuminated by an artificial light source and a natural light source. Storing a brightness characteristic of the environment allows the computer system to simulate the brightness characteristic of the environment when the illumination state of the environment was stored at a point in time where the brightness characteristic is not naturally present within the environment, thereby improving the feedback and/or reducing the number of inputs needed to perform an operation.

In some embodiments, the illumination state includes an amount of light present (e.g.,. 1 lux-300 lux) in the environment (and, in some embodiments, the illumination state includes the amount of light present as a result of the environment being illuminated by the light source (e.g., 610a-610d, 616a-616d, 610, and/or 616)). In some embodiments, the illumination state includes an amount of light present in the environment as a result of the environment being illuminated by the light source (e.g., 610a-610d, 616a-616d, 610, and/or 616) and an external light source (e.g., a light source different from the light source). In some embodiments, the amount of light present in the environment is a result of the environment being illuminated by an artificial light source and a natural light source. Storing an amount of light characteristic of the environment allows the computer system to simulate the amount of light present in the environment when the illumination state of the environment was stored at a point in time where said amount of light is not naturally present within the environment, thereby improving the feedback and/or reducing the number of inputs needed to perform an operation.

In some embodiments, before (e.g., or while, or after) detecting the request to save the illumination state of the environment, the computer system (e.g., 600) detects a second request (e.g., tap input, swipe input, rotation of a physical input mechanism, gaze, and/or voice command) to illuminate the environment. In some embodiments, in response to detecting the second request to illuminate the environment, the computer system illuminates, via the light source (e.g., 610a-610d, 616a-616d, 610, and/or 616), the environment. In some embodiments, the environment is illuminated with the first diffusion pattern. In some embodiments, the environment is illuminated with a respective diffusion pattern that is different than the first diffusion pattern. In some embodiments, the environment is not illuminated with a respective diffusion pattern. In some embodiments, the environment ceases to be illuminated in response to the computer system detecting the request to save the illumination state of the environment. In some embodiments, the environment continues to be illuminated in response to the computer system detecting the request to save the illumination state of the environment. Illuminating the environment in response to detecting the second request to illuminate the environment allows a user to change how the environment is illuminated via input, thereby performing an operation when a set of conditions has been met without requiring further user input and providing additional control options without cluttering the user interface.

In some embodiments, the environment is illuminated, via the light source (e.g., 610a-610d, 616a-616d, 610, and/or 616), with the illumination state that includes the first diffusion pattern (e.g., where the illumination of the first diffusion pattern occurs over a period of time (e.g., 1-60 mins)) in response to detecting the second request to illuminate the environment.

In some embodiments, in response to detecting the request to illuminate the environment, the computer system (e.g., 600) forgoes illuminating, via the light source (e.g., 610a-610d, 616a-616d, 610, and/or 616), the environment with (e.g., based on and/or according to) the first diffusion pattern. In some embodiments, the environment is illuminated with a respective diffusion pattern different from the first diffusion pattern in response to detecting the request to illuminate to illuminate the environment.

In some embodiments, the environment is illuminated, via the light source (e.g., 610a-610d, 616a-616d, 610, and/or 616), with (e.g., based on, according to) the first diffusion pattern while detecting the request to save the illumination state. In some embodiments, after detecting the request to save the illumination state of the environment (e.g., in response to detecting the request to save the illumination state of the environment) (e.g., immediately after or a predetermined period of time after) and without detecting a third request to change the illumination of the environment, the computer system (e.g., 600) illuminates, via the light source (e.g., 610a-610d, 616a-616d, 610, and/or 616), the environment with (e.g., based on, according to) a third diffusion pattern different from the first diffusion pattern. In some embodiments, the third diffusion pattern can be saved in response to detecting another request to save the illumination state of the environment (e.g., over a predetermined period of time that occurs before, after, and/or while the environment is illuminated via the light source with the third diffusion pattern). Illuminating the environment with the third diffusion pattern after detecting the request to save the illumination state of the environment and without detecting a request to change the illumination of the environment allows the computer system to automatically alert the user that the request to save the illumination state of the environment was detected (e.g., and/or that the illumination state of the environment was saved), thereby improving the feedback, performing an operation when a set of conditions has been met without requiring further user input, and/or reducing the number of inputs needed to perform an operation.

In some embodiments, the light source (e.g., 610a-610d, 616a-616d, 610, and/or 616) includes a first external light (e.g., an illumination device, a point light source, a spotlight, and/or one or more light sources) and a second external light (e.g., an illumination device, a point light source, a spotlight, and/or one or more light sources)).

In some embodiments, the environment is a first environment. In some embodiments, after storing the illumination state of the first environment (e.g., or while or in response to storing the illumination state), the computer system (e.g., 600) detects a request (e.g., a swipe input, tap input, voice command, gaze input, voice command, and/or air hand gesture) to illuminate a second environment (e.g., an environment that is separate and/or distinct from the environment) different from the first environment. In some embodiments, in response to detecting the request to illuminate the second environment, the computer system causes the second environment to be illuminated with (e.g., based on and/or according to) the first diffusion pattern (e.g., and not the second diffusion pattern). In some embodiments, the second environment is automatically (e.g., without intervening input) illuminated with the first diffusion pattern after the illumination state of the environment is stored. In some embodiments, the second environment is illuminated with the first diffusion pattern in response to detecting an input. In some embodiments, the second diffusion pattern is not defined but rather depends on one or more objects in the environment. In some embodiments, causing the second environment to be illuminated with (e.g., based on, and/or according to) the first diffusion pattern includes causing a second computer system (e.g., that is present in the second environment) to illuminate the second environment using one or more different light sources than the light source. In some embodiments, an illumination state saved in one environment can be used to illuminate another environment by another computer system and/or the computer system that saved the illumination state when the computer system moves to the other environment. In some embodiments, the computer system is in a live communication session with (e.g., text messaging session, video session, telephone call) the second computer system when the computer system causes the additional environment to be illuminated with the first diffusion pattern. Illuminating the second environment in response to detecting the request to illuminate the second environment allows the computer system to mimic the lighting conditions of the first environment in environments that are external to the first environment, thereby performing an operation when a set of conditions has been met without requiring further user input, providing additional control options without cluttering the user interface, and/or providing improved visual feedback.

In some embodiments, the illumination state is a first illumination state. In some embodiments, while the first illumination state of the environment is saved and while the environment is being illuminated by the light source (e.g., 610a-610d, 616a-616d, 610, and/or 616), the computer system (e.g., 600) detects, via the input device, a request to save a second illumination state (e.g., a lighting state) of the environment (e.g., that is different from the first illumination state). In some embodiments, detecting the request includes detecting an input (e.g., a tap gesture, a long press gesture, a verbal request and/or command, a physical button press, a pointing input and/or air gesture, and/or a rotation of a physical input mechanism) corresponding to the request. In some embodiments, detecting the request includes receiving a message from another computer system, the message indicating that the request was received by the other computer system. In some embodiments, while the first illumination state of the environment is saved, in conjunction with (e.g., before, while, in response to, and/or after) detecting the request to save the second illumination state of the environment, the computer system stores the second illumination state of the environment, wherein the second illumination state includes a fourth diffusion pattern, different than the first diffusion pattern (e.g., present in the environment (e.g., as a result of the environment being illuminated by the light source)). In some embodiments, after storing the second illumination state of the environment, the computer system illuminates, via the light source, the environment with the fourth diffusion pattern in response to detecting a request to illuminate the environment with the fourth diffusion pattern. In some embodiments, in conjunction with (e.g., before, while, in response to, and/or after) detecting the request to save the second illumination state of the environment, the computer system outputs an indication that the second illumination state has been saved (and, in some embodiments, without displaying and/or outputting the indication that the first illumination state has been saved). In some embodiments, the indication that the second illumination state has been saved is different from the indication that the first illumination state has been saved. In some embodiments, the indication that the second illumination state has been saved indicates the fourth diffusion pattern and not the first diffusion pattern while the indication that the first illumination state has been saved indicates the first diffusion pattern and not the fourth diffusion pattern. Storing the second illumination state of the environment while the first illumination state of the environment is saved allows the computer system to cause the light source to mimic the separate and/or discrete lighting conditions of the environment, thereby providing improved feedback and/or reducing the number of inputs needed to perform an operation.

In some embodiments, while the illumination state of the environment is saved and the environment is being illuminated by the light source (e.g., 610a-610d, 616a-616d, 610, and/or 616), the computer system (e.g., 600) detects a change in illumination of the environment without detecting a request to save the changed illumination of the environment (and, in some embodiments, without detecting a request to change illumination of the environment, where the illumination changes due to changes in natural light and/or natural obstructions in some embodiments). In some embodiments, in response to detecting the change in illumination of the environment without detecting a request to save the changed illumination of the environment (e.g., automatically, without intervening user input to change the state of the environment) (and, in some embodiments, without detecting a request to change illumination of the environment, where the illumination changes due to changes in natural light and/or natural obstructions in some embodiments), the computer system stores the changed illumination state of the environment, wherein the changed illumination state includes a fifth diffusion pattern without including the first diffusion pattern. Storing the changed illumination state of the environment when a set of prescribed conditions is met (e.g., a change in the illumination of the environment is detected) automatically (e.g., without intervening user input) allows the computer system to store various illumination states of the environment over a period of time as the illumination states of the environment changes, thereby performing an operation when a set of conditions has been met without requiring further user input.

Note that details of the processes described above with respect to method 700 (e.g., FIG. 7) are also applicable in an analogous manner to other methods described herein. For example, method 900 optionally includes one or more of the characteristics of the various methods described above with reference to method 700. For example, a physical space can be illuminated based on the illumination of an external environment using one or more techniques described herein in relation to method 900, where the diffusion pattern of the physical space can be stored using one or more techniques described herein in relation to method 700. For brevity, these details are not repeated herein.

FIGS. 8A-8D illustrate exemplary environments for simulating lighting conditions in accordance with some embodiments. The environments in these figures are used to illustrate the processes described below, including the processes in FIG. 9 and FIG. 10.

FIGS. 8A-8D illustrate exemplary techniques for simulating lighting conditions in accordance with some embodiments. The techniques in these figures are used to illustrate the processes described below, including the processes in FIG. 9.

FIGS. 8A-8D illustrate physical space 608, which is a room that contains lights 616, couch 614, clock 612b, and window 612a. Lights 616 illuminate physical space 608 and/or portions of physical space 608. Lights 616 includes individual lights 616a, 616b, 616c, and 616d, which can individually be turned off, turned on, and/or set to have different characteristics to providing lighting in physical space 608. While discussed below that a controller device detects inputs and causes light sources 616 to perform an operation, it should be recognized that one or more computer systems can detect sensor data, communicate the sensor data, determine an operation to perform in response to the sensor data, and/or cause an operation to be performed. For example, a personal device of a user can receive an image of physical space 608 from a camera separate from the personal device, detect an input in physical space 608, and, in response, perform an operation. In some embodiments, light sources 616 can communicate with one or more sensor devices directly and/or indirectly via one or more computing devices that are in communication with the one or more sensor devices. In some embodiments, the one or more sensor devices detect changes and/or the level of one or more properties of a physical space, such as an amount of ambient light and/or movement in the environment. As another example, light sources 616 can communicate with one or more processing devices that process sensor data, determine illumination levels, and/or process inputs that assist and/or instruct light sources 616 to output illumination as described in the examples described herein. For ease of explanation, various operations (e.g., outputting illumination, detecting input, and/or determining properties) are described below as being performed by light sources 616. However, it should be recognized that one or more of the operations described below is performed by a device different from light sources 616, such as one or more personal computing devices (e.g., a phone, a tablet, a laptop, a desktop, an HMD device, and/or a wearable device) and/or communal devices (e.g., a smart speaker, a television, a router, and/or a hub). In some embodiments, the one or more computing devices and/or communal devices include one or more features and/or components of devices 100, 300, and/or 500 as described above. Unless otherwise noted explicitly, this description should not be construed as limiting the scope of such operations to be performed by a single device (e.g., light sources 616) or a particular combination of devices.

In some embodiments, light sources 616 work in tandem to create a visual effect in physical space 608 including simulating one or more shadows, shapes, and/or objects that are projected in physical space 608. In some embodiments, light sources 616 change to simulate lighting conditions of a particular time throughout the day according to the location of physical space 608 and/or lighting conditions throughout the day according to the location of an environment that is remote to physical space 608. In some embodiments, light sources 616 actively emit light into physical space 608. In some embodiments, rather than actively emitting light to illuminate physical space 608, light sources 616 can allow light to pass through physical space 608. For example, in a scenario where light sources 616 are a skylight, light sources 616 can change (e.g., such as a movable cover for one or more of light sources 616 changing position and/or a tint over one or more light sources 616 increasing and/or decreasing) to allow more or less light from the physical environment exterior physical space 608 (e.g., outside of the building and/or house) to enter into physical space 608 (e.g., inside of the building and/or house). In some embodiments, other types of light sources than those described herein are recognized and can be implemented using one or more techniques.

FIG. 8A illustrates physical space 608 at 3:00 PM, sunlight from sun 618 is passing through window 612a in physical space 608. At FIG. 8A, a controller device detects a request to illuminate physical space 608. In some embodiments, the controller device detects the request by detecting an input from a user, such as the user verbally requesting to illuminate physical space 608, the user performing one or more air gestures in physical space 608, and/or the user performing one or more inputs (e.g., a swipe input, a tap input, a drag input, etc.) directed to the controller. In some embodiments, the controller device detects the request by detecting a request via an application executing on the controller device. In some embodiments, the controller device detects the request in response to an occurrence of an event configured with the application for illuminating physical space 608. In some embodiments, the request is obtained from another computer system, such as a computer system that has initiated and/or is in a communication session (e.g., a telephone call, a video call, a live communication session, and/or a messaging session) with the controller device. In some embodiments, the request to illuminate physical space 608 is a request to illuminate a portion of physical space 608, such as the floor, a portion of the wall, and/or a one or more objects in physical space 608. In some embodiments, before receiving the request to illuminate a portion of physical space 608, an illumination pattern is set that causes one or more of lights 616 to illuminate physical space 608 in a certain manner. In some embodiments, the illumination pattern defines how light is illuminated in physical space 608 over a period of time. In some moments, the illumination pattern includes how light is diffused throughout physical space 608 over a period of time. In some embodiments, the illumination pattern is based on an historical illumination pattern and/or how light illuminated the environment over a previous period of time, where the historical illumination pattern causes light 612 to illuminate physical space 608 at a current time in a manner in which physical space 608 was illuminated in previously. In some embodiments, the historical illumination pattern being set causes light 612 to project shadows into the environment that were present in the environment at a previous point in time.

As illustrated in FIG. 8B, in response to detecting the request to illuminate physical space 608, the controller device causes light sources 616 to illuminate region 800, which is a portion of floor 674. Region 800 illustrated in FIG. 8B represents a portion of illumination that is different from illumination in another portion (e.g., the rest) of physical space 608. In some embodiments, light sources 616 illuminate region 800 in response to detecting the request to illuminate a subset of physical space 608 rather than all of physical space 608. At FIG. 8B, the controller device detects an input corresponding to a request to change a time defined for illumination within region 800. In some embodiments, the input to change a time defined for illumination of a region physical space 608 is a swipe input, dragging input, and/or a movement input from one position to another position. In some embodiments, the input is a scrubbing input and/or a touch input on a touch-sensitive display of a user device. In some embodiments, touch input that the user device detects is directed to a slider user interface element (e.g., a slider). In some embodiments, the slider is a scale type of user interface element on which the user can move a sliding tool up and down or left and right.

In some embodiments, an input moving the slider to the right or in an upward direction increases the time that light sources 616 display within region 800. At FIG. 8B, the current time in physical space 608 is 3:00 PM. In some embodiments, when a user makes an input on the scale user interface element moving the slider to the right or in an upwards direction, the time of day that light sources 616 uses to illuminate region 800 is changed. That is, if the middle of the scale is 3:00 and the user moves the slider to the right or up, the illumination that light sources 616 outputs will correspond to the lighting conditions at 4:00 instead of 3:00. As the user continues to move the slider further to the right or up, the lighting conditions of region 800 will correspond to 5:00, 6:00, 7:00, etc. If the user makes an input on the scale user interface element moving the slider to the left or in a downwards direction, the time of day that light sources 616 indicate by region 800 decreases. That is, if the middle of the scale is 3:00 and the user moves the slider to the left or down, the illumination that light sources 616 outputs will correspond to the lighting conditions at 2:00. As the user continues to move the slider further to the left or down, the lighting conditions of region 800 will correspond to 1:00, 12:00, 11:00, and etc.

In some embodiments, the illumination changes in relation to an input. In some embodiments, the illumination changes as the drag input takes place. For example, if a user drags the slider user interface element from 3:00 to 4:00 to 5:00, the lighting conditions change dynamically from conditions of 3:00 to 4:00 to 5:00, respectively, as the slider moves. In some embodiments, the input changes after the user releases the input. For example, if a user drags the slider user interface element from 3:00 to 4:00 to 5:00, the lighting conditions will change from 3:00 to 5:00 only after detecting a release of input from the slider user interface element.

In some embodiments, lighting conditions are customized. In some embodiments, the user can request that the lighting be based on a location other than the present environment. For example, a user can say, “show me the lighting in Texas,” and lights 616 can output current lighting conditions in Texas (e.g., according to one or more weather patterns and/or external information regarding light in the state of Texas). In some embodiments, the verbal request mentions a specific time of the different location. For example, a user can say “Show me Texas lighting at 10 AM,” and lights 616 can illuminate physical space 608 based on detected lighting conditions in the state of Texas at 10 AM.

In some embodiments, the user can request lighting conditions at a certain time. In some embodiments, the user can predefine the size and/or location of the illuminated region of the environment. For example, a user can say, “Show me Texas lighting in a 2×2 portion of the floor.” In some embodiments, the size and/or location of the illuminated region of the environment is automatically determined. For example, the size of the illuminated region can be based on avoiding users and/or furniture and/or if a user is looking in a certain direction. In some embodiments, the user defines the size and/or location of the illuminated region of the environment with a verbal request and/or an air gesture. For example, a user can say “Illuminate the left side of the room.” For another example, a user can move their hands and/or fingers to indicate an input to alter the lighting conditions according to a future or past time. In some embodiments, air gestures are detected via a camera within physical space 608.

As illustrated in FIG. 8C, in response to detecting the request to change the time, the controller device causes light sources 616 to change illumination within region 800. Illumination of region 802 in FIG. 8C represents a time of day other than 3:00 PM. For example, the lighting conditions of region 800 indicate the lighting conditions of 4:00, as the user has moved the slider on the scale user interface element to the right on the user device (e.g., a scrubbing input). Note that even though region 802 represents the lighting conditions of 4:00, the current time within physical space 608 is 3:00, as indicated by clock 612b. Region 802 represents 4:00 as the user scrubbed the slider to the right from its position corresponding to 3:00. The difference in lighting conditions from FIG. 8B to FIG. 8C is represented by the hashing inside region 800 changing direction as compared to the hashing of region 802.

In some embodiments, the lights in physical space 608 stop illuminating. In some embodiments, the lights in physical space 608 stop illuminating after a predefined period of time has passed. For example, if lights 616 are outputting a certain lighting pattern, they will automatically cease outputting the pattern after a certain period of time has passed (e.g., 3 hours). In some embodiments, the lights in the environment stop illuminating after a predefined period of time unless an input is received to maintain the illumination. For example, a user can configure lights 616 to cease outputting a pattern after an amount of time chosen by the user (e.g., 3 minutes, 1 hour, 1 day).

In some embodiments, the illumination is as based on conditions of a different environment. In some embodiments, the illumination is based on the time of day of the different environment. For example, if the current time of a different environment is 5 PM and the current time of physical space 608 is 3 PM, region 802 can be illuminated according to the lighting conditions at 5 PM in the different environment. Further, the user can scrub the illumination of region 802 from 5 PM in the different environment to 6 PM in the different environment. In some embodiments, the illumination changes as time passes in the different environment. For example, if region 802 is set to the lighting conditions of a different environment, the illumination of region 802 will change according to the natural changes in lighting according to the different environment. More specifically, if physical space 608 is located in Texas and region 802 is set to the lighting conditions of New York, region 802 will become darker more quickly than the remaining portion of physical space 608 due to the sun setting in New York earlier than in Texas. At FIG. 8C, the controller detects another request to illuminate physical space 608. For example, the user makes a request (e.g., voice input, touch input, and/or air gesture) for light sources 616 to illuminate more than a portion of physical space 608.

As illustrated in FIG. 8D, in response to detecting the request to illuminate physical space 608, light sources 616 illuminate a different portion of physical space 608 in a manner similar to region 802 in FIG. 8C. That is, in FIG. 8D, light sources 616 illuminate both region 802 and another region of physical space 608 with the same illumination represented by region 802 in FIG. 8C. At FIG. 8D, the entirety of physical space 608 is illuminated with the same illumination represented by region 802 in FIG. 8C. In some embodiments, fewer light sources are used to illuminate a portion of physical space 608 than are used to illuminate all of physical space 608. For example, illuminating region 802 can use one light source and illuminating all of region 802 can use four light sources. For another example, illuminating region 802 can use two light sources and illuminating all of region 802 can use three light sources. In some embodiments, light sources 616 can switch back and forth from illuminating region 802 to illuminating all of physical space 608. In some embodiments, light sources 616 can switch back and forth from illuminating region 802 to illuminating all of physical space 608 after a predetermined period of time has passed. For example, if lights 616 are illuminating region 802 and a predetermined period of time (e.g., three hours, 12 hours, 1 day) passes, lights 616 cease illuminating region 802 and begin illuminating all of physical space 608, and vice versa. In some embodiments, the illumination ceases. In some embodiments, the illumination turns off if an input satisfies a set of criteria. For example, if a user makes an input to change the lighting conditions to a time that requires no light (e.g., nighttime), lights 616 cease illumination. For another example, lights 616 cease illumination if a user makes an input to turn off the lights within physical space 608.

FIG. 9 is a flow diagram illustrating a method (e.g., method 900) for simulating lighting conditions in accordance with some embodiments. Some operations in method 900 are, optionally, combined, the orders of some operations are, optionally, changed, and some operations are, optionally, omitted.

As described below, method 900 provides an intuitive way for simulating lighting conditions. Method 900 reduces the cognitive burden on a user, thereby creating a more efficient human-machine interface. For battery-operated computing devices, enabling a user to simulate lighting conditions faster and more efficiently conserves power and increases the time between battery charges.

In some embodiments, method 900 is performed at a computer system (e.g., 600) that is in communication with an external light source (e.g., an illumination device, a point light source, a spotlight, and/or one or more light sources) and an input device (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device. In some embodiments, the external light source is not physically connected to and/or coupled to the computer system. In some embodiments, the computer system is in communication with one or more cameras. In some embodiments, the one or more cameras are not physically connected to the external light source (e.g., as described above in relation to FIGS. 8A-8D).

The computer system (e.g., 600) detects (902), via the input device, a request to illuminate a first physical space (e.g., 608) (e.g., a physical environment, at least a partially enclosed area, a room, an office, and/or a building) (and/or a region of the first physical space) based on (and/or according to) a second physical space different from the first physical space, wherein the second physical space is outside of (e.g., different from, separate from, on opposite sides of a surface, and/or at a different location in a physical environment) the first physical space (and, in some embodiments, the first physical space is not included within the second physical space). In some embodiments, detecting the request includes detecting an input (e.g., a tap gesture, a long press gesture, a verbal request and/or command, a physical button press, a pointing gesture and/or air gesture, and/or a rotation of a physical input mechanism) corresponding to the request. In some embodiments, detecting the request includes receiving a message from another computer system, the message indicating that the request was received by the other computer system. In some embodiments, detecting the request is irrespective of input. In some embodiments, detecting the request includes detecting an event has occurred in the first physical space and/or the second physical space (e.g., as described above in relation to FIGS. 8A-8D).

In response to (904) detecting the request to illuminate the first physical space (e.g., 608) based on the second physical space and in accordance with a determination that the second physical space has a first context (e.g., a context that includes one or more illumination properties and/or light properties, such as the color, brightness, intensity, warmth, and/or tone of light and/or illumination of a physical space), the computer system (e.g., 600) illuminates (906), via the external light source (e.g., 610a-610d, 616a-616d, 610, and/or 616), a first region (e.g., an area, a portion, and/or a part) of the first physical space in a first manner (e.g., to include one or more lighting properties (e.g., colors, tones, brightness levels, and/or intensity levels) that correspond to and/or that match the first context of the second physical space and/or the second physical space at an instance of time) without illuminating (and/or changing illumination of) (e.g., via the external light source) a second region of the first physical space in the first manner, wherein the second region is different from the first region (e.g., as described above in relation to FIGS. 8A-8D).

In response to (904) detecting the request to illuminate the first physical space based on the second physical space and in accordance with a determination that the second physical space has a second context different from the first context, the computer system (e.g., 600) illuminates (908), via the external light source (e.g., 610a-610d, 616a-616d, 610, and/or 616), the first region of the first physical space in a second manner different from the first manner (e.g., to include one or more lighting properties (e.g., colors, tones, brightness levels, and/or intensity levels) that correspond to and/or that match the second context of the second physical space and/or the second physical space at an instance of time) (e.g., without illuminating, via the external light source, the first region of the first physical space in the second manner). In some embodiments, illuminating the first region includes activating the external light source. In some embodiments, illuminating the first region includes changing light output by the external light source. In some embodiments, illuminating the first region includes sending a request to the external light source to modify light being output by the external light source (e.g., 610a-610d, 616a-616d, 610, and/or 616) (e.g., as described above in relation to FIGS. 8A-8D). Selectively illuminating the first region of the first physical space when a set of prescribed conditions is satisfied automatically allows the computer system to illuminate the first region of the first physical space in a manner that mimics the illumination of the second physical space, thereby performing an operation when a set of conditions has been met without requiring further user input.

In some embodiments, the request includes an identification (e.g., a name, coordinates, characteristics, and/or description) of the second physical location (e.g., a physical location of the first physical space, a physical location of the second physical space, and/or a physical location that provides the basis for illuminating the first physical space) (e.g., a region of the first physical space, a region of the second physical space, a region external to both the first physical space and/or the second physical space, a city, town, state, landmark and/or celestial object). In some embodiments, in accordance with a determination that the second physical location is a first respective location and/or has a first set of properties (e.g., color, light, illumination, and/or weather), the computer system (e.g., 600) illuminates the first region of the first physical space in a first respective manner and in accordance with a determination that the second physical location is a second respective location and/or has a second set of properties different from the first set of properties, the computer system illuminates the first region of the first physical space in a second respective manner different from the first respective manner (e.g., as described above in relation to FIGS. 8A-8D). Illuminating the first region of the first physical space in a respective manner in response to detecting a request to illuminate the first physical space based on a second physical location, where the request includes an identification of the second physical location, allows the computer system to illuminate the first physical space based one or more expressed preferences of the user, thereby providing improved visual feedback and/or performing an operation when a set of conditions is met without requiring further user input.

In some embodiments, the request includes an identification (e.g., digits of a time, time zone (e.g., pacific, cast, and/or central time zone), AM, and/or PM) of a time (e.g., a time that corresponds to the second physical space (e.g., a previous, current, and/or future time of the second physical space), a time that corresponds to the current illumination of the first physical space) (e.g., a previous, current, or future time of the first physical space). In some embodiments, the time is a previous, current, or future time (e.g., as described above in relation to FIGS. 8A-8D). Illuminating the first region of the first physical space in a respective manner in response to detecting a request to illuminate the first physical space based on a second physical location, where the request includes an identification of a time, allows the computer system (e.g., 600) to illuminate the first physical space based one or more expressed preferences of the user, thereby providing improved visual feedback and/or performing an operation when a set of conditions is met without requiring further user input.

In some embodiments, the first physical space consists of the first region and the second region. In some embodiments, while illuminating, via the external light source (e.g., 610a-610d, 616a-616d, 610, and/or 616), the first region of the first physical space in the first manner without illuminating the second region of the first physical space in the first manner, the computer system (e.g., 600) detects the occurrence of a first event (e.g., an input (e.g., tap input, swipe input, hand air gesture, gaze, rotation of a physical input mechanism, and/or voice command), time of day, detection of an object within the first physical region, detecting that the noise volume within the first physical space exceeds a volume threshold, and/or detecting that the brightness within the first physical space exceeds a brightness threshold). In some embodiments, in response to detecting the occurrence of the first event, the computer system illuminates, via the external light source, the first region and the second region of the first physical space (e.g., the entirety of the first physical space) in the first manner. In some embodiments, the first region and the second region are illuminated in the same manner. In some embodiments, the first region and the second region are illuminated in different manners. In some embodiments, the first region and the second region are concurrently illuminated. In some embodiments, the first region and the second region are sequentially illuminated. In some embodiments, the first region or the second region is illuminated at any single point in time (e.g., as described above in relation to FIGS. 8A-8D). Illuminating the first region and the second region of the first physical space in the first manner when a set of prescribed conditions is met automatically allows the computer system to at least partially immerse a user within the context of the second physical space, thereby performing an operation when a set of conditions has been met without requiring further user input.

In some embodiments, detecting the occurrence of the first event includes detecting that a first predefined amount of time (e.g., 1-600 seconds) has expired (e.g., as described above in relation to FIGS. 8A-8D). Illuminating the second region of the first physical space in the first manner in response to detecting the expiration of the first predefined amount of time allows the computer system (e.g., 600) to stagger the illumination of different portions of the first physical space such that the illumination of the entirety of the first physical space is not changed at the same time, thereby providing additional control options without cluttering the user interface with additional displayed controls.

In some embodiments, detecting the occurrence of the first event includes detecting an input (e.g., swipe input, tap input, gaze, voice command, rotation of a physical input mechanism, and/or air gesture). In some embodiments, the input is different and/or distinct from the request to illuminate the first physical space based on the second physical space. In some embodiments, the input is the same as the request to illuminate the first physical space based on the second physical space (e.g., as described above in relation to FIGS. 8A-8D). Illuminating the second region of the first physical space in the first manner in response to detecting the input allows the computer system to stagger the illumination of different portions of the first physical space such that the illumination of the entirety of the first physical space is not changed at the same time, thereby providing improved feedback.

In some embodiments, illuminating, via the external light source (e.g., 610a-610d, 616a-616d, 610, and/or 616), the first region of the first physical space includes causing a single external light source to illuminate the first region without causing another external light source to illuminate the first region. In some embodiments, the second region of the first physical space is illuminated using multiple light sources (e.g., first light source and a second light source that is different from the first light source) (e.g., as described above in relation to FIGS. 8A-8D).

In some embodiments, while illuminating, via the external light source (e.g., 610a-610d, 616a-616d, 610, and/or 616), the first region of the first physical space (e.g., in the first manner or in the second manner, or in a respective manner that is different from the first manner and/or the second manner), the computer system (e.g., 600) detects the expiration of a second predefined period of time (e.g., 1-600 seconds) (e.g., that start elapsing after illuminating the first physical space in the first manner or the second manner and/or after detecting the request to illuminate the first physical space based on the second physical space). In some embodiments, in response to detecting the expiration of the second predefined period of time, the computer system ceases to illuminate, via the external light source, the first region of the first physical space. In some embodiments, the second region of the first physical space continues to be illuminated in response to detecting the expiration of the second predefined period of time. In some embodiments, after ceasing to illuminate the first region of the first physical space and in accordance with a determination that another predefined period of time has elapsed, the first region of the first physical space is illuminated again (e.g., as described above in relation to FIGS. 8A-8D). Ceasing to illuminate the first region of the first physical space in response to detecting the expiration of the second predefined period of time allows the computer system to automatically stop illuminating the first physical space based on context of the second physical space after the user has had an adequate amount of time to view and analyze the context of the second physical space and is not interested in the context of the second physical space, thereby providing additional control options without cluttering the user interface with additional displayed controls.

In some embodiments, while illuminating, via the external light source (e.g., 610a-610d, 616a-616d, 610, and/or 616), the first region of the first physical space (e.g., in the first manner or in the second manner), the computer system (e.g., 600) detects an expiration of a third predefined period of time (e.g., 1-600 seconds). In some embodiments, in response to detecting the expiration of the third predefined period of time and in accordance with a determination that a respective input (e.g., swipe input, tap input, rotation of physical input mechanism, gaze input, voice command, and/or hand air gesture) was not detected before the expiration of the third predefined period of time (e.g., immediately after the expiration of the third predefined period of time or within a threshold amount of time (e.g., 1-60 seconds) of the expiration of the third predefined period of time), the computer system ceases to, via the external light source, illuminate the first region of the first physical space. In some embodiments, in response to detecting the expiration of the third predefined period of time and in accordance with a determination that the respective input was detected before the expiration of the third predefined period of time (e.g., immediately after the expiration of the third predefined period of time or within a threshold amount of time (e.g., 1-60 seconds) of the expiration of the third predefined period of time), the computer system continues, via the external light source, to illuminate the first region of the first physical space. In some embodiments, the second region of the physical space remains illuminated after the first physical space ceases to be illuminated. In some embodiments, the second region continues to be illuminated in accordance with a determination that the input is detected after the expiration of the third predefined period of time (e.g., as described above in relation to FIGS. 8A-8D). Selectively continuing to illuminate the first region of the first physical space when a set of prescribed conditions is met (e.g., the computer system detected the respective input before the expiration of the third predefined period of time) automatically allows the computer system to intelligently illuminate the first region of the first physical space based on the desires of the user, thereby performing an operation when a set of conditions has been met without requiring further user input.

In some embodiments, before (e.g., or while or after) detecting the request to illuminate the first physical space based on the second physical space, the computer system (e.g., 600) detects, via the input device, an input (e.g., a swipe, tap, rotation of physical input mechanism, voice command, and/or gaze) corresponding to (e.g., selection of, election of, and/or choosing) a first respective region of the first physical space (e.g., a wall, a ceiling, a floor, a door, and/or a window of the first respective region). In some embodiments, in response to detecting the input corresponding to the first respective region of the first physical space, the computer system designates (e.g., assigning, setting, appointing, and/or selecting) the first respective region of the first physical space as the first region of the physical space. In some embodiments, the first respective region of the first physical space remains designated as the first region of the physical space until an expiration of a period of time. In some embodiments, the first respective region of the first physical space remains designated as the first region of the physical space until the user selects a different region of the physical space as the first region. In some embodiments, the first respective region of the first physical space includes two or more discrete areas of the first physical space. In some embodiments, the computer system designates a respective region of the first physical space as the second region in response to detecting a user input. In some embodiments, in response to detecting the input corresponding to a second respective region of the physical space, the computer system does not designate the first respective region of the first physical space as the first region of the physical space and designates the second respective region of the physical space as the first region of the physical space. In some embodiments, the first respective region and/or the second respective region is different from the second region (e.g., as described above in relation to FIGS. 8A-8D). Designating the first respective region of the first physical space as the first region of the physical space in response to detecting the input corresponding to the first respective region of the physical space allows the computer system to illuminate a portion of the first physical space with the context of the second physical space based on user preference, thereby providing additional control options without cluttering the user interface with additional displayed controls and/or providing improved feedback (e.g., that the computer system has detected the input corresponding to the first respective region of the first physical space).

In some embodiments, before (e.g., or while or after) detecting the request to illuminate the first physical space based on the second physical space, the computer system (e.g., 600) designates (e.g., assigns, setts, appoints, and/or selects), without detecting intervening input, a third respective region of the first physical space as the first region. In some embodiments, the third respective region of the first physical space is designated as the first region based on objects (e.g., furniture and/or users) that are positioned within the first physical space. In some embodiments, the third respective region of the first physical space is designated as the first region based on a context of the first physical space (e.g., brightness, noise level, and/or color of light of the first physical space). In some embodiments, the third respective region of the first physical space is designated as the first region based on a location of where an interaction (e.g., a video call and/or one or more graphics for a live communication session) between the computer system in the first physical space is taking place with a computer system in the second physical space (e.g., as described above in relation to FIGS. 8A-8D). Designating, without detecting intervening input, the third respective region of the first physical space as the first region allows the computer system to optimize the location of the illumination of the first physical space based on objects within the first physical space and/or the configuration (e.g., shape and/or size) of the first physical space, thereby providing additional control options without cluttering the user interface with additional displayed controls.

In some embodiments, the request to illuminate the first physical space based on the second physical space is a first request. In some embodiments, after (e.g., or while, or before) illuminating, via the external light source (e.g., 610a-610d, 616a-616d, 610, and/or 616), the first region of the first physical space, the computer system (e.g., 600) detects, via the input device, a second request (e.g., a voice command, a tap input, a swipe input, gaze input, depression of a physical input mechanism and/or air hand gesture) to illuminate the first physical space based on the second physical space (e.g., to illuminate the first region and/or the second region of the first physical space). In some embodiments, detecting the second request includes detecting an input (e.g., a tap gesture, a long press gesture, a verbal request and/or command, a physical button press, a pointing gesture and/or air gesture, and/or a rotation of a physical input mechanism) corresponding to the second request. In some embodiments, detecting the second request includes receiving a message from another computer system, the message indicating that the second request was received by the other computer system. In some embodiments, detecting the second request is irrespective of an input. In some embodiments, detecting the second request includes detecting an event has occurred in the first physical space and/or the second physical space. In some embodiments, after illuminating, via the external light source (e.g., 610a-610d, 616a-616d, 610, and/or 616), the first region of the first physical space, in response to detecting the second request to illuminate the first physical space based on the second physical space and in accordance with a determination that the second request is a first type of request (e.g., includes a request to illuminate the entirety of the first physical space, includes a request to illuminate a portion of the first physical space, first type of input, first type of hand air gesture, first type of body movement), the computer system (e.g., 600) illuminates, via the external light source, the first region of the first physical space without illuminating the second region of the first physical space (e.g., the first physical space is illuminated in the first manner, the second manner and/or a third manner). In some embodiments, after illuminating, via the external light source, the first region of the first physical space, in response to detecting the second request to illuminate the first physical space based on the second physical space and in accordance with a determination that the second request is a second type of request (e.g., includes a request to illuminate the entirety of the first physical space, includes a request to illuminate a portion of the first physical space, second type of input, second type of hand air gesture, second type of body movement) different from the first type of request, the computer system illuminates, via the external light source, the first region of the first physical space and the second region of the first physical space (e.g., the first physical space is illuminated in the first manner, the second manner, and/or the third manner). In some embodiments, the first region of the physical space and the second region of the physical space are illuminated in different manners. In some embodiments, the first region of the physical space and the second region of the physical space are illuminated in the same manner. In some embodiments, the external light source transitions from illuminating the first region of the first physical space without illuminating the second region of the first physical space to illuminating the first region and the second region of the first physical space (e.g., as described above in relation to FIGS. 8A-8D). Selectively illuminating the first physical space when a set of prescribed conditions is met automatically provides the computer system with the ability to illuminate the first physical space in different ways, thereby performing an operation when a set of conditions has been met without requiring further user input.

In some embodiments, while illuminating, via the external light source (e.g., 610a-610d, 616a-616d, 610, and/or 616), the first region of the first physical space in the first manner without illuminating the second region of the first physical space in the first manner, the computer system (e.g., 600) detects the occurrence of a second event (e.g., the detection of a user input, a change in context of the first physical space and/or second physical space, the expiration of a period of time, receiving a phone call, receiving a text message, and/or receiving an e-mail). In some embodiments, in response to detecting the occurrence of the second event, the computer system illuminates, via the external light source, the first region of the first physical space in the first manner and the second region of the first physical space in the first manner. In some embodiments, while illuminating, via the external light source, the first region of the first physical space in the first manner and the second region of the first physical space in the first manner, the computer detects the occurrence of a third event. In some embodiments, in response to detecting the occurrence of the second event, the computer system illuminates the first region of the first physical space in the first manner without illuminating the second region of the first physical space in the first manner (e.g., as described above in relation to FIGS. 8A-8D). Illuminating the first region of the first physical space in the first manner and the second region of the first physical space in the first manner in response to detecting the occurrence of the second event allows the computer system to modify the lighting conditions of discrete portions of the first physical space independently of each other, thereby providing additional control options without cluttering the user interface with additional displayed controls and/or performing an operation when a set of conditions has been met without requiring further user input.

In some embodiments, the size of the first region of the first physical space is predefined (e.g., predefined by a user, the computer system (e.g., 600), or the manufacturer of the computer system) (and/or is not dependent on request). In some embodiments, the size of the first region of the first physical space is fixed (e.g., static) when the size of the first region of the first physical space is predefined. In some embodiments, the size of the first region of the first physical space is dynamic when the size of the first region of the first physical space is predefined. In some embodiments, the size of the second region of the first physical space is not predefined. In some embodiments, the size of the second region of the first physical space is predefined (e.g., as described above in relation to FIGS. 8A-8D).

In some embodiments, in response to detecting the request to illuminate the first physical space based on the second physical space, the computer system (e.g., 600) designates (e.g., assigns, sets, and/or determines) a size (e.g., an area measured in feet, inches, or meters) of the first region of the first physical space (e.g., and not the second region of the first physical space), wherein the size of the first region of the first physical space is set using the request to illuminate the first physical space based on the second physical space. In some embodiments, in response to detecting the second request to illuminate the first physical space based on the second physical space, a size is designated to the first region and the second region of the first physical space (e.g., as described above in relation to FIGS. 8A-8D).

In some embodiments, illuminating, via the external light source (e.g., 610a-610d, 616a-616d, 610, and/or 616), in the first manner includes: during a first period of time while providing the illumination in the first manner, changing, via the light source, the illumination by a first illumination amount and during a second period of time, different from the first period of time, while providing the illumination in the first manner, changing, via the light source, the illumination by a second illumination amount different from the first illumination amount. In some embodiments, while providing, via the light source, illumination in the first manner, the computer system detects the expiration of a period of time (e.g., 1-600 seconds). In some embodiments, in response to detecting the expiration of the period of time and without detecting an input (e.g., without intervening input, automatically), the computer system: ceases providing illumination in the first manner and provides, via the light source, illumination in a fourth manner (e.g., a location, a color, an intensity, and/or a size of illumination) different (e.g., the light source outputs more or less illumination while outputting illumination in the fourth manner than the when the light source outputs illumination in the first and/or second manner) from the first and/or second manner. In some embodiments, the light source ceases to provide illumination in the fourth manner and provides illumination in the first and/or second manner in response to the detection of the expiration of a respective period of time (e.g., as described above in relation to FIGS. 8A-8D). Changing the illumination by a first illumination amount during the first time period and changing the illumination by a second illumination amount during the second time period allows the computer system to dynamically change the lighting conditions within the first physical space based on one or more conditions, thereby providing additional control options without cluttering the user interface with additional displayed controls and/or performing an operation when a set of conditions has been met without requiring further user input.

In some embodiments, the external light source (e.g., 610a-610d, 616a-616d, 610, and/or 616) includes a first external light and a second external light different from the first external light. In some embodiments, illuminating, via the external light, in the first manner includes: causing the first external light (e.g., an illumination device, a point light source, a spotlight, and/or one or more light sources) to provide first illumination; and causing the second external light (e.g., an illumination device, a point light source, a spotlight, and/or one or more light sources) to provide second illumination (e.g., separate from and/or different from the first illumination). In some embodiments, the first illumination is a different amount, different shape, different color, different tone, and/or different brightness than the second illumination. In some embodiments, the first external light and the second external light are the same types of lights. In some embodiments, the first external light and the second external light are different types of light (e.g., a ceiling light, a floor light, a light bulb, an LED light, a halogen light, a light that is fixed and/or attached to the physical space, and/or a light that is not attached and/or fixed to the physical space). In some embodiments, the first illumination is the same amount, same shape, same color, same tone, and/or same brightness as the second illumination (e.g., as described above in relation to FIGS. 8A-8D). Causing the first external light to provide first illumination and causing the second external light to provide illumination when a set of prescribed conditions is met automatically allows the computer system to concurrently illuminate the first physical space using multiple light sources, thereby performing an operation when a set of conditions has been met without requiring further user input.

Note that details of the processes described above with respect to method 900 (e.g., FIG. 9) are also applicable in an analogous manner to other methods described herein. For example, method 1000 optionally includes one or more of the characteristics of the various methods described above with reference to method 900. For example, a physical space can be illuminated based on the illumination of an external environment using one or more techniques described herein in relation to method 900, where the physical space is illuminated based on a time of day using one or more techniques described herein in relation to method 1000. For brevity, these details are not repeated herein.

FIG. 10 is a flow diagram illustrating a method (e.g., method 1000) for simulating lighting conditions based on a time of day in accordance with some embodiments. Some operations in method 1000 are, optionally, combined, the orders of some operations are, optionally, changed, and some operations are, optionally, omitted.

As described below, method 1000 provides an intuitive way for simulating lighting conditions based on a time of day. Method 1000 reduces the cognitive burden on a user, thereby creating a more efficient human-machine interface. For battery-operated computing devices, enabling a user to cause the simulation of lighting conditions based on a time of day faster and more efficiently conserves power and increases the time between battery charges.

In some embodiments, method 1000 is performed at a computer system (e.g., 600) in communication with an external light source (e.g., 610a-610d, 616a-616d, 610, and/or 616) (e.g., an illumination device, a point light source, a spotlight, and/or one or more light sources) and an input device (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device. In some embodiments, the external light source is not physically connected to and/or coupled to the computer system. In some embodiments, the computer system is in communication with one or more cameras. In some embodiments, the one or more cameras are not physically connected to the external light source.

While illuminating, according to (and/or based on) a first time of day, a first space (e.g., a first physical space, a first virtual space, a first region of a physical environment, and/or a physical environment) via the external light source (e.g., 610a-610d, 616a-616d, 610, and/or 616), the computer system (e.g., 600) detects (1002), via the input device, an input (e.g., a slide input, a drag input, and/or a select-and-drag input) (e.g., as described above in relation to FIGS. 8A-8D).

In response to (1004) detecting the input and in accordance with a determination that the input corresponds to a second time of day different from the first time of day, the computer system illuminates (1006), according to (and/or based on) the second time of day (e.g., and not the first time of day), the first space via the external light source (e.g., as described above in relation to FIGS. 8A-8D).

In response to (1004) detecting the input and in accordance with a determination that the input corresponds to a third time of day different from the first time of day and the second time of day, the computer system (e.g., 600) illuminates (1008), according to (and/or based on) the third time of day (e.g., and not the first time of day or the second time of day), the first space via the external light source (e.g., 610a-610d, 616a-616d, 610, and/or 616). In some embodiments, illuminating, according to (and/or based on) the second time of day, the first time of day causes the external light source to illuminate the first physical space differently (e.g., more light, less light, and/or light with more or less of a characteristic (e.g., amount of light, brightness, color, shadows, warmness, coolness and/or saturation)) (e.g., as described above in relation to FIGS. 8A-8D). Selectively illuminating the first space based on a respective time of day when a set of prescribed conditions is satisfied automatically allows the computer system to mimic lighting conditions that correspond to various times of the day of the first space or a space external to the first space, thereby performing an operation when a set of conditions has been met without requiring further user input.

In some embodiments, the first time of day corresponds to (e.g., is, is based on, and/or mimics) a first current time (e.g., the current time at the first space and/or the current time at the second space) (e.g., as described above in relation to FIGS. 8A-8D). Illuminating the first space according to a current time of day allows the computer system to provide a user with an indication with respect to the present time (e.g., the morning, the afternoon, or the evening) at the first space of the computer system or a space that is external to the first space, thereby providing improved feedback.

In some embodiments, the second time (e.g., or the third time) of day corresponds to (e.g., is, is based on, and/or mimics) a second current time (e.g., the current time at the first space and/or the current time at the second space) (e.g., as described above in relation to FIGS. 8A-8D). Illuminating the first space according to a second current time of day when a set of prescribed conditions is met automatically allows the computer system to provide an indication of the present time (e.g., the morning, the afternoon, or the evening) at the first space of the computer system or a space that is external to the first space, thereby performing an operation when a set of conditions has been met without requiring further user input.

In some embodiments, while illuminating the first space via the external light, the computer system (e.g., 600) detects, via the input device, the input moving from a first position to a second position different from the first position. In some embodiments, the input remains in contact with the computer system, a button remains depressed, the computer system continues to detect the voice command, and/or a rotatable input mechanism continues to be rotated. In some embodiments, in response to detecting the input moving from the first position to the second position, the computer system changes, via the external light source, the illumination of the first space (e.g., change the brightness of the illumination, change the color of the illumination, change the tone of the illumination, and/or change the hue of the illumination). In some embodiments, the computer system ceases to illuminate the first space in response to ceasing to detect the second input. In some embodiments, the computer system continues to illuminate the first space in response to ceasing to detect the second input. In some embodiments, the first position corresponds to a first respective time of day and the second position corresponds to a second respective time of day different from the first respective time of day (e.g., as described above in relation to FIGS. 8A-8D). Changing the illumination of the first space in response to detecting the input move from a first position to a second position allows a user of the computer system to scrub through various representations of lighting conditions at different times of the day, thereby reducing the number of inputs needed to perform an operation and/or providing improved visual feedback.

In some embodiments, detecting the input includes detecting lift-off (e.g., release and/or ceasing to detect contact) of the input (e.g., the input is no longer in contact with the computer system (e.g., 600) and/or the input moves to a different area of a touch-sensitive display of the computer system) (e.g., at a position that corresponds to the second time of day or the third time of day) (and, in some embodiments, after detecting that the input has moved from a position that corresponds to the first time of day) (e.g., as described above in relation to FIGS. 8A-8D). Illuminating the first region of the first physical space in response to detecting lift-off of the input allows the computer system to change the illumination upon determining that the input has ended and reduces changing the illumination in situations where the user does not want to change the illumination (e.g., where the user has not perform a lift-off portion of an input), thereby providing improved feedback and/or providing additional control options without cluttering the user interface with additional displayed controls.

In some embodiments, in accordance with a determination that the input is detected in a first direction (e.g., the input is detected as moving to the left, to the right, upwards, and/or downwards) (e.g., a voice command (e.g., the past and/or before the current time) indicates the first direction, a hand and/or another portion (e.g., face, nose, body, and/or leg) of a user moves in the first direction, a user interface element is moved in the first direction, a user interface element is rotated in the first direction, a slider is moved in the first direction, and/or a dial is rotated in the first direction), the second time of day and the third time of day occur before the first time of day (e.g., the second time of day and the third time of day occur in the morning and the first time of day occurs in the evening or the second time of day and the third time of day occur in the afternoon and the first time of day occurs in the evening). In some embodiments, in accordance with a determination that the input is detected in a second direction (e.g., the input is detected as moving to the left, to the right, upwards, and/or downwards) (e.g., a voice command (e.g., the future and/or after the current time) indicates the second direction, a hand and/or another portion of a user moves in the second direction, a user interface element is moved in the second direction, a user interface element is rotated in the second direction, a slider is moved in the second direction, and/or a dial is rotated in the second direction) different from the first direction (e.g., the second direction is opposite the first direction, the second direction is perpendicular to the first direction, the second direction is angled to the first direction), the second time of day and the third time day occur after the first time of day (e.g., the second time of day and the third time of day occur in the evening and the first time of day occurs in the morning or the second time of day and the third time of day occur in the evening and the first time of day occurs in the afternoon). In some embodiments, the first direction is opposite to the second direction (e.g., as described above in relation to FIGS. 8A-8D). Selectively illuminating the first space according to a respective time of day relative to the first time of day when a set of prescribed conditions is met automatically allows the computer system to illuminate the first space based on historical lighting conditions and/or future lighting conditions, thereby performing an operation when a set of conditions has been met without requiring further user input.

In some embodiments, the input corresponds to the second time of day. In some embodiments, in accordance with a determination that the input includes a first amount of displacement (a first amount of displacement upwards, downwards, to the left and/or to the right) (e.g., the user's hand moves in the first amount, a user interface element is moved by the first amount, a user interface element is rotated by the first amount, a slider is moved by the first amount, and/or a dial is rotated by the first amount), the difference in time between the first time of day and the second time of day is a first amount of time difference (e.g., seconds, minutes, and/or hours). In some embodiments, in accordance with a determination that the input includes a second amount of displacement (a second amount of displacement upwards, downwards, to the left and/or to the right) (e.g., the user's hand moves in the second amount, a user interface element is moved by the second amount, a user interface element is rotated by the second amount, a slider is moved by the second amount, and/or a dial is rotated by the second amount) different than the first amount of displacement (e.g., the first amount is more or less than the first amount), the difference in time between the first time of day and the second time of day is a second amount (e.g., seconds, minutes, and/or hours) of time difference different from the first amount of time difference (e.g., as described above in relation to FIGS. 8A-8D). Selectively illuminating the first space based on a respective amount of displacement of the input automatically allows the computer system to illuminate the first space based on various different times of day that are removed from the first time of day, thereby performing an operation when a set of conditions has been met without requiring further user input.

In some embodiments, the second time of day corresponds to (e.g., is, is based on, and/or mimics) a time (e.g., previous time, current time, or future time) of day with respect to (e.g., of and/or at) a second physical space (e.g., a room, a city, a town, and/or a state) (e.g., a space that is greater than a predetermined distance (e.g., 1-100000 miles) from the first physical space) that is external (e.g., separate and/or distinct) to the first physical space. In some embodiments, the third time of day corresponds to a time (e.g., previous time, current time, or future time) of day with respect to the second space that is external to the first space. In some embodiments, the first space and the second space are positioned in different physical structures (e.g., buildings and/or homes). In some embodiments, the first space and the second space are positioned in the same physical structures. In some embodiments, the computer system (e.g., 600) is in the first physical space and in communication with (e.g., via a live video call, a live messaging session, and/or a telephone call) a computer system in the second physical space (e.g., as described above in relation to FIGS. 8A-8D). Illuminating the first space according to a time of day of a second physical space that is external to the first physical space when a set of prescribed conditions is met automatically allows the computer system to provide an indication of a current lighting condition at a location that is different from the location of the computer system, thereby performing an operation when a set of conditions has been met without requiring further user input.

In some embodiments, the second time of day corresponds to (e.g., is, is based on, and/or mimics) a time (e.g., previous time, current time, or future time) with respect to a third current location of the computer system (e.g., at the first space). In some embodiments, the third time of day corresponds to (e.g., is, is based on, and/or mimics) a time (e.g., previous time, current time, or future time) of the current location of the computer system. In some embodiments, the second time of day and the third time of day correspond to a current location of the user. In some embodiments, the second time of day and the third time of day correspond to a current location of an external computer system that is in communication with the computer system (e.g., as described above in relation to FIGS. 8A-8D).

In some embodiments, the input device includes a touch-sensitive surface (e.g., a touch screen and/or touch pad) (e.g., as described above in relation to FIGS. 8A-8D).

In some embodiments, the input device includes a set of one or more cameras. In some embodiments, when the input device is a set of one or more cameras, the input is an air tap gesture, air swipe gesture, pinch gesture, and/or de-pinch gesture. In some embodiments, when the input device is a set of one or more cameras, the one or more cameras record and/or detect the input (e.g., as described above in relation to FIGS. 8A-8D). Illuminating the first space via the external light source in response to detecting, via one or more cameras, the input allows the computer system to control the illumination of the first space without requiring that a user physically interact with the computer system, thereby providing additional control options without cluttering the user interface with additional displayed controls.

In some embodiments, the external light source (e.g., 610a-610d, 616a-616d, 610, and/or 616) includes, at least, a first external light source (e.g., an illumination device, a point light source, a spotlight, and/or one or more light sources) and a second external light source (e.g., an illumination device, a point light source, a spotlight, and/or one or more light sources). In some embodiments, the first external light and the second external light are the same types of lights. In some embodiments, the first external light and the second external light are different types of light (e.g., a ceiling light, a floor light, a light bulb, an LED light, a halogen light, a light that is fixed and/or attached to the physical space, and/or a light that is not attached and/or fixed the physical space). In some embodiments, the first external light and the second external light output the same amount of illumination. In some embodiments, the first external light and the second external light output different amounts of illumination. In some embodiments, the first external light and the second external light output different colors of light. In some embodiments, the first external light and the second external light output the same color of light. In some embodiments, illuminating according to a particular time of day includes causing the first external light (e.g., an illumination device, a point light source, a spotlight, and/or one or more light sources) to provide first illumination and causing the second external light (e.g., an illumination device, a point light source, a spotlight, and/or one or more light sources) to provide second illumination (e.g., separate from and/or different from the first illumination) (e.g., as described above in relation to FIGS. 8A-8D). Illuminating the first space via a first external light source and a second external light source allows the computer system to simultaneously illuminate two discrete portions of the first space according to a respective time of day (e.g., the second time of day or the third time or day), thereby reducing the number of inputs needed to perform an operation.

In some embodiments, in response to detecting the input and in accordance with a determination that the input satisfies a set of one or more criteria (e.g., the input corresponds to a respective time of day that does not include ambient lighting (e.g., the evening and/or early morning), the input corresponds to a selection of a user interface object that, when selected, causes the external light source (e.g., 610a-610d, 616a-616d, 610, and/or 616) to turn off, and/or the input corresponds to a time of day where the ambient illumination is equal or greater to a light threshold), the computer system (e.g., 600) ceases illuminating the first space via the external light source. In some embodiments, after ceasing illuminating the first space, the first space is illuminated via the external light source in response to detecting a respective input. In some embodiments, in response to detecting the input and in accordance with a determination that the input does not satisfy the set of one or more criteria, the computer system continues to illuminate the first space via the external light source (e.g., as described above in relation to FIGS. 8A-8D). Selectively ceasing the illumination of the first space via the external source when a set of prescribed conditions is met automatically allows the computer system the ability to adjust the ambiance and brightness within the first space based on one or more expressed preferences of the user (e.g., the user does not wish to have the first space illuminated with the context of the second space), thereby performing an operation when a set of conditions has been met without requiring further user input.

In some embodiments, the computer system (e.g., 600) is in communication (e.g., wired communication and/or wireless communication) with a display generation component (e.g., computer monitor, touch sensitive display, head mounted display, and/or television). In some embodiments, before detecting the input, the computer system displays, via the display generation component, a user interface element (e.g., a graphical user interface element and/or a textual user interface element), wherein the input corresponds to a selection of the user interface element. In some embodiments, the input corresponds to movement of the user interface element. In some embodiments, the input corresponds to rotation of the user interface element. In some embodiments, the user interface element ceases to be displayed in response to detecting the input. In some embodiments, the user interface element continues to be displayed in response to detecting the input (e.g., as described above in relation to FIGS. 8A-8D). Displaying the user interface before detecting the input allows the computer system to provide an indication with respect to the state of the computer system (e.g., the computer system is not causing illumination of the first space according to a respond time of day), thereby providing improved visual feedback.

Note that details of the processes described above with respect to method 1000 (e.g., FIG. 10) are also applicable in an analogous manner to other methods described herein. For example, method 700 optionally includes one or more of the characteristics of the various methods described above with reference to method 1000. For example, illumination can be provided within a physical space based on a time of day using one or more techniques described herein in relation to method 1000, where the diffusion pattern of the physical space can be saved using one or more techniques described herein in relation to method 700. For brevity, these details are not repeated herein.

FIGS. 11A-11C illustrate exemplary environments for duplicating lighting conditions in accordance with some embodiments. The environments in these figures are used to illustrate the processes described below, including the processes in FIG. 12.

FIGS. 11A-11C illustrate a scenario in which the lighting conditions in an environment of a recipient of a video conference call is changed based on the lighting conditions of an environment of an individual that initiated the video conference call. More specifically, the lighting of the environment of the recipient of the video conference call is changed to match the lighting of the environment of the individual that initiated the video conference call.

FIG. 11A illustrates computer system 1100. In FIGS. 11A-11C computer system 1100 is owned and/or operated by a user named Joe. In FIGS. 11A-11C, both computer system 1100 and Joe are positioned in a common environment (e.g., Joe is holding computer system 1100 and/or Joe is wearing computer system 1100).

In FIGS. 11A-11C, computer system 1100 is depicted as a smartphone. While computer system 1100 is illustrated in FIGS. 11A-11C as a smartphone, it should be recognized that this is merely an example and techniques described herein can be performed with other types of computer systems, such as a tablet, a smart watch, laptop, a personal gaming system, a head-mounted display (HMD) device that has augmented reality and/or virtual reality capabilities, and/or a desktop computer.

As illustrated in FIG. 11A, computer system 1100 displays incoming call user interface 1102. Computer system 1100 displays incoming call user interface 1102 in response to computer system 1100 receiving a telecommunications connection request (e.g., a phone call, video conference call, and/or a multiway call) from an external computer system (e.g., a computer system that is positioned within a different environment from computer system 1100 or a computer system that is positioned with the same environment as computer system 1100). As illustrated in FIG. 11A, incoming call user interface 1102 includes caller indicator 1104, which, in this example, indicates the individual that owns and/or is operating the external computer system that initiated the telecommunications connection request. Accordingly at FIG. 11A, Megan (e.g., the owner and/or operator of the external computer system) is calling Joc (e.g., the owner and/or operator of computer system 1100).

As illustrated in FIG. 11A, incoming call user interface 1102 also includes decline control 1106, answer without illumination control 1108, and answer with illumination control 1110. Computer system 1100 rejects the telecommunications connection request in response to detecting an input that corresponds to selection of decline control 1106. As discussed in greater detail below, computer system 1100 accepts the telecommunications connection request without causing the illumination of the environment of Joe (e.g., the owner of computer system 1100) to change in response to detecting an input that corresponds to selection of answer without illumination control 1108. As discussed in greater detail below, computer system 1100 accepts the telecommunications connection request while causing the illumination of the environment of Joe to match the illumination of the environment of Megan (e.g., the owner and/or operator of the external computer system that initiated the telecommunications connect request) response to detecting an input that corresponds to selection of answer with illumination control 1110.

At FIG. 11A, computer system 1100 displays answer with illumination control 1110 as filled with a respective color (e.g., as represented by the hatching within answer with illumination control 1110) that is representative of the current illumination of the environment of Megan. For example, if Megan's environment is illuminated with a red color at the time the telecommunications connection request is initiated, computer system 1100 displays answer with illumination control 1110 as filled with a red color. For another example, if Megan's environment is illuminated with flashing strobe lights at the time the telecommunications connection request is initiated, computer system 1100 displays answer with illumination control 1110 as a flashing light. In some embodiments, before computer system 1000 accepts or rejects the telecommunications connection request, computer system 1100 causes one or more external lights (e.g., ceiling lights, spotlights, floor lights, and/or a beam of light) within Joe's environment to illuminate a portion (e.g., a subset and/or a region) of Joe's environment in a manner that mimics the current lighting conditions of Megan's environment. For example, if Megan's environment is illuminated with a pink colored light at the time the telecommunications connection request is initiated, computer system 1100 causes the one or more external lights in Joe's environment to illuminate a portion (e.g., a wall, a circle, a 3-dimensional column of light) (e.g., less than the entirety of the Joe's environment) with a pink color in response to receiving the telecommunications connection request (e.g., and as a part of displaying incoming call user interface 1102). In some embodiments, the Joe's environment is concurrently illuminated with multiple colors of light (e.g., a first color of that illuminated Joe's environment prior to computer system 1100 receiving the telecommunications connection request and a color of light that mimics that color of light present in the environment of Megan). At FIG. 11A, computer system 1100 detects tap input 1105a1 that corresponds to selection of answer without illumination control 1108. In some embodiments, at FIG. 11A, computer system 1100 detects input 1105a2 that corresponds to selection of answer with illumination control 1110. In some embodiments, input 1105a2 is a tap input, swipe input, rotation of a rotatable input mechanism, voice command, gaze input, and/or an air gesture (e.g., air tap, air pinch, and/or air de-pinch)

At FIG. 11B, in response to detecting input 1105a2, computer system 1100 accepts the telecommunications connection request from the external computer system. As illustrated in FIG. 11B, as part of accepting the telecommunications connection request, computer system 1100 displays video feed user interface 1112. At FIG. 11B, computer system 1100 displays a real time video feed of one or more cameras of the external computer system (e.g., the computer system belonging to Megan) on the left half of video feed user interface 1112 and computer system 1100 displays a real time video feed of one or more cameras of computer system 1100 on the right half of video feed user interface 1112. More specifically, the left half of video feed user interface 1112 includes a live video representation of Megan in her respective environment and the right half of video feed user interface 1112 includes a live video representation of Joe in his respective environment. At FIG. 11B, Megan and Joe are positioned in separate environments.

As illustrated in FIG. 11B, Megan is positioned underneath lights 1118a and 1118b and Joe is positioned underneath light 1120. At FIG. 11B, light 1118a and light 1118b are outputting red light (e.g., as represented by the diagonal hatching that fills light 1118a and light 1118b) and light 1120 is outputting green light (e.g., as represented by the cross hatching that fills light 1120). The difference in appearance of the hatching of lights 1118a-b versus light 1120 is due to different lighting conditions in the two environments. Accordingly, at FIG. 11B, Megan's environment is illuminated differently than Joe's environment. As discussed above, computer system 1100 does not cause the illumination of Joe's environment to change in response to detecting an input that corresponds to selection of answer without illumination control 1108, which answers the incoming call without altering the illumination of the environment of user 1116. In some embodiments, Megan's environment is a virtual environment. For example, the Joe can be positioned in a real-world physical environment while receiving a video feed of Megan within a virtual environment.

As illustrated in FIG. 11B, video feed user interface 1112 includes controls region 1122. At FIG. 11B, controls region 1122 includes end control 1122a, duration indicator 1122b, and change background control 1122c. End control 1122a, when selected, causes the telecommunications connection between computer system 1100 and the external computer system to end. Duration indicator 1122b indicates the duration of the telecommunications connection between computer system 1100 and the external computer system. Accordingly, at FIG. 11B, the telecommunications connection between computer system 1100 and the external computer system has lasted for one second. As discussed in greater detail below, in response to detecting an input corresponding to selection of change background control 1122c, computer system 600 causes the illumination within Joe's environment to mimic the illumination of Megan's environment. At FIG. 11B, computer system 1100 detects input 1105b that corresponds to selection of change background control 1122c. In some embodiments, input 1105b is a tap input, swipe input, rotation of a rotatable input mechanism, voice command, gaze input, and/or an air gesture (e.g., air tap, air pinch, and/or air de-pinch).

At FIG. 11C, in response to detecting input 1105b that corresponds to the selection of change background control 1122c, computer system 1100 transmits instructions to light 1120 that cause light 1120 to cease outputting green colored light and begin to output red colored light (e.g., as indicated by the diagonal hatching within light 1120 at FIG. 11C). That is, in response to detecting selection of change background control 1122c, computer system 1100 causes the lights (e.g., light 1120) in Joe's environment to output light in a fashion that the output of light in Megan's environment. For example, if the lights in Megan's environment were providing light in a pulsating fashion, upon detecting selection of change background control 1122c, computer system 1100 causes light 1120 to output light in a pulsating fashion. In some embodiments, in response to detecting the selection of change background control 1122c, computer system 1100 causes the operation of multiple light in Joe's environment to change to match the operation of lights in Megan's environment. For example, computer system 1100 causes the operation of two or more light sources in Joe's environment to mimic the operation of lights in Megan's environment.

As discussed above, in response to detecting an input that corresponds to selection of answer with illumination control 1110, computer system 1000 accepts the telecommunications connection request and causes the illumination within Joe's environment to change to mimic the illumination within Megan's environment. In some embodiments, at FIG. 11A, computer system 1100 detects input 1105a2 (e.g., as does not detect input 1105a1) as illustrated in FIG. 11A. In response to detecting input 1105a2 at FIG. 11A, computer system 1100 displays video feed user interface 1112 (e.g., as illustrated in FIG. 11B) and modifies the operation of light 1120 within Joe's environment to match illumination within Megan's environment (e.g., as described above in FIG. 11C). That is, in response to detecting selection of answer with illumination control 1110, computer system 1100 changes the illumination of Joe's environment of user 1116 to match the illumination of Megan's environment in conjunction with accepting the telecommunications connection request.

As mentioned above, in some embodiments, computer system 1100 is a head-mounted display (e.g., hereinafter “HMD”) device that has augmented and/or virtual reality capabilities. That is, in some embodiments, at FIGS. 11B and 11C, computer system 1100 displays Megan as being positioned within a virtual environment rather than a physical environment. In some embodiments, when computer system 1100 is an HMD device, in response to accepting the telecommunications connection request from Megan, computer system 1100 displays a representation of light that mimics one or more qualities of the light from Megan's environment, as emanating from a respective answer control (e.g., answer without illumination control 1108 and/or answer with illumination control 1110) into Joe's environment. For example, if Megan's environment is illuminated with purple color, in response to computer system 1100 detecting input 1105a2, computer system 1100 displays a purple color as spreading outwards from answer with illumination control 1110. Computer system 1100 displays the purple color as spreading outwards from answer with illumination control 1110 until the color reaches the edges of the display of computer system 1100.

FIG. 12 is a flow diagram illustrating a method (e.g., method 1200) for duplicating lighting conditions in accordance with some embodiments. Some operations in method 1200 are, optionally, combined, the orders of some operations are, optionally, changed, and some operations are, optionally, omitted.

As described below, method 1200 provides an intuitive way for duplicating lighting conditions. Method 1200 reduces the cognitive burden on a user, thereby creating a more efficient human-machine interface. For battery-operated computing devices, enabling a user to cause the duplication of illumination conditions faster and more efficiently conserves power and increases the time between battery charges.

In some embodiments, method 1200 is performed at a computer system (e.g., 1100) that is in communication with a light source (e.g., 1118a-1118b and/or 1120) (e.g., an illumination device, a point light source, a spotlight, and/or one or more light sources), an input device (e.g., a camera, a depth sensor, a microphone, a hardware input mechanism, a rotatable input mechanism, a heart monitor, a temperature sensor, and/or a touch-sensitive surface), and a display generation component (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device. In some embodiments, the light source is not physically connected to and/or coupled to the computer system.

While causing a first environment (e.g., a physical environment) (e.g., as described above in relation to FIGS. 11A-11D) to be illuminated (and/or while the environment is being illuminated) by the light source (e.g., 1118a-1118b and/or 1120) (e.g., based on the first environment and/or another environment different from the first environment), the computer system (e.g., 1100) displays (1202), via the display generation component, a user interface element (e.g., 1110) including: (1204) in accordance with a determination that a second environment (e.g., as described above in relation to FIGS. 11A-11D) (e.g., a physical environment or a virtual environment), different from the first environment, has a first illumination, a first representation of the second environment, wherein the first representation has a first appearance based on the first illumination and in accordance with (1206) a determination that the second environment has a second illumination different from the first illumination, a second representation (e.g., different from the first representation) of the second environment, wherein the second representation has a second appearance based on the second illumination, and wherein the second appearance is different from the first appearance.

The computer system (e.g., 1100) detects (1208), via the input device, a first set of one or more inputs (e.g., 1105a1 and/or 1105a2) (e.g., a tap input and/or a non-tap input (e.g., a verbal input, an audible request, an audible command, an audible statement, a swipe input, a hold-and-drag input, a gaze input, an air gesture, and/or a mouse click)), wherein the first set of one or more inputs includes an input corresponding to (e.g., selection of) the user interface element (e.g., as described above in relation to FIGS. 11A-11D).

In response to detecting the first set of one or more inputs (e.g., 1105a1-1105a2), the computer system (e.g., 1100) illuminates (1210), via the light source (e.g., 1118a-1118b and/or 1120), the first environment based on illumination (e.g., the first illumination or the second illumination) of the second environment. In some embodiments, illuminating the first environment based on illumination of the second environment includes: in accordance with a determination that the second environment has the first illumination, illuminating, via the light source, the first environment with a third illumination (e.g., the first illumination or another illumination different from the first illumination and the second illumination); and in accordance with a determination that the second environment has the second illumination, illuminating, via the light source, the first environment with a fourth illumination (e.g., the second illumination or another illumination different from the first illumination, the second illumination, and the third illumination) (e.g., as described above in relation to FIGS. 11A-11D). Selectively displaying a respective representation with a respective appearance when a set of prescribed conditions is met automatically allows the computer system to indicate the illumination state of the second environment, thereby performing an operation when a set of conditions has been met without requiring further user input.

In some embodiments, the user interface element (e.g., 1108 and/or 1110) is displayed in response to the computer system (e.g., 1100) detecting a telecommunications request (e.g., a phone call, a video conference request, a text message, and/or electronic mail) (e.g., a request to connect and/or acceptance of joining a connection) from a first external computer system (e.g., 1100) (e.g., a computer system that is positioned within an external environment different from the environment of the computer system) (e.g., different from the computer system) (e.g., as described above in relation to FIGS. 11A-11D). In some embodiments, the computer system ceases to display the user interface element in response to the telecommunications connection request being accepted or rejected. In some embodiments, the user interface element continues to be displayed in response to the telecommunications connection request being accepted or rejected. In some embodiments, the computer system and the first external computer system are the same type of computer system. In some embodiments, the computer system and the first external computer system are different types of computer systems. In some embodiments, the user interface element is displayed while the telecommunications connection request is pending (e.g., as described above in relation to FIGS. 11A-11D). Displaying the user interface element in response to the computer system detecting a telecommunications request from a first external computer system allows the computer system to alert a user to the state of the computer system (e.g., the computer system is presently receiving a phone call), thereby performing an operation when a set of conditions (e.g., the computer system is receiving a phone call) has been met without requiring further user input and providing improved visual feedback to the user.

In some embodiments, the first external computer system (e.g., 1100) (e.g., and/or a user of the first external computer system) is positioned (e.g., previously positioned, currently positioned and/or will be positioned) within the second environment (e.g., and not the first environment) (e.g., while and/or when the telecommunications request is initiated). In some embodiments, the first external computer system moves outside of the second environment after the telecommunications connection request is initiated. In some embodiments, the first external computer system remains within the second environment after the telecommunications connection request is initiated (e.g., as described above in relation to FIGS. 11A-11D). Selectively displaying a respective representation with a respective appearance that is based on the lighting conditions of an environment of an individual who initiated the telecommunications connection allows the computer system to indicate the conditions of the individual's environment prior to accepting the telecommunications connection, thereby providing improved feedback.

In some embodiments, the first external computer system (e.g., 1100) (e.g., and/or a user of the first external computer system) is positioned within a third environment different from (e.g., separate from, external to, distinct from) the second environment (e.g., and different from the first environment) (e.g., when and/or while the telecommunications connection request is initiated) and the first environment (e.g., as described above in relation to FIGS. 11A-11D). In some embodiments, the first environment and the third environment are in a common space (e.g., a home, office building, and/or school) (e.g., as described above in relation to FIGS. 11A-11D). In some embodiments, the lighting in the first environment and the third environment are different. In some embodiments, the lighting in the first environment and the third environment are the same.

In some embodiments, in response to detecting the first set of one or more inputs (e.g., 1105a1 and/or 1105a2), the computer system (e.g., 1100) initiates a first telecommunications connection (e.g., initiating a phone call and/or initiating a video conference) between the computer system and a second external computer system (e.g., initiating a phone call between the computer system and the second external computer system, initiating a video conference between the computer system and the second external computer system) (e.g., as described above in relation to FIGS. 11A-11D). In some embodiments, the telecommunications connection between the computer system and the second external computer system is initiated before, after, or while the first environment is illuminated based on the illumination of the second environment. In some embodiments, the first environment ceases to be illuminated based on the second environment in response to the telecommunications connection between the computer system and the second external computer system ending. Initiating a first telecommunications connection between the computer system and a second external computer system in response to detecting the first set of one or more inputs allows the computer system to perform two different operations (e.g., initiate a phone call and illuminate the first environment based on the illumination of the second environment) in response to detecting the same set of one or more inputs, thereby providing an additional control option without cluttering the user interface and reducing the number of inputs needed to perform one or more operations.

In some embodiments, initiating the first telecommunications connection between the computer system (e.g., 1100) and the second external computer system includes displaying, via the display generation component, a representation (e.g., an image, text, and/or video (e.g., live video call of the environment of the second external computer system)) corresponding to the second external computer system (e.g., a representation of a user of the second external computer system, a representation of the location of the second external computer system, and/or a representation of the type of device of the second external computer system) (e.g., a representation of a user captured by one or more cameras of the second external computer system and/or that are in communication with the second external computer system). In some embodiments, the representation of the second external computer system is received from the second external computer system. In some embodiments, the representation of the second external computer system is received via the telecommunications connection between the computer system and the second external computer system. In some embodiments, the representation of the second external computer system is received via a respective connection between the computer system and the second external computer system that is not the telecommunications connection. In some embodiments, the representation of the second external computer system is displayed during the duration for which the computer system and the second external computer system are connected. In some embodiments, the representation of the second external computer system is displayed for a period of time (e.g., 1-60 seconds) (e.g., as described above in relation to FIGS. 11A-11D). Displaying a representation corresponding to the second external computer system as part of initiating the first telecommunications connection between the computer system and the second external computer system allows the computer system to provide a visual indication of the second external computer system to the user such that the user can verify the identity of the other party to the telecommunications connection, thereby providing improved visual feedback and increasing the security of the telecommunications connection.

In some embodiments, the user interface element (e.g., 1105a1 and/or 1105a2) is a first user interface element. In some embodiments, after (e.g., or before) illuminating the first environment based on the illumination of the second environment, while causing the first environment to be illuminated by the light source (e.g., 1118a-1118b and/or 1120), the computer system (e.g., 1100) displays, via the display generation component: the first user interface element and a second user interface element different from the first user interface element (e.g., the second user interface element has a different appearance, size, shape, and/or graphical elements than the first user interface element). In some embodiments, the first user interface element and the second user interface element are displayed in response to the computer system receiving a telecommunications connections request. In some embodiments, while causing the first environment to be illuminated by the light source, while displaying the first user interface element and the second user interface element (e.g., and causing the first environment to be illuminated by the light source), the computer system detects an input (e.g., tap input, swipe input, voice command, gaze input, and/or air hand gesture) corresponding to selection of the second user interface element (e.g., and not the first user interface element). In some embodiments, in response to detecting the input corresponding to selection of the second user interface element, the computer system initiates a second telecommunications connection between the computer system and the second external computer system (e.g., initiating a phone call and/or initiating a video conference between the computer system and the external computer system) without changing the illumination of the first environment (e.g., without changing a brightness, color, tone, hue, and/or intensity of the illumination of the first environment). In some embodiments, the computer system continues to display the first user interface element and the second user interface element in response to detecting the input corresponding to selection of the second user interface element. In some embodiments, the computer system ceases to display the first user interface element and the second user interface element in response to detecting the input corresponding to selection of the second user interface element (e.g., as described above in relation to FIGS. 11A-11D). Initiating a second telecommunications connection between the computer system and the second external computer system without changing the illumination of the first environment in response to detecting the input corresponding to selection of the second user interface element allows the computer system to initiate the phone call between the computer system and the second external computer system without disrupting the lighting conditions of the environment of the recipient of the phone call, thereby providing improved feedback and performing an operation when a set of conditions (e.g., selection of the second user interface element and not the first user interface element) has been met without requiring further user input.

In some embodiments, the computer system (e.g., 1100) is a head-mounted computer system. In some embodiments, the head mounted computer system is configured to display virtual reality (e.g., computer generated virtual objects and/or a computer-generated virtual environment that a user can interact with) or (e.g., and) augmented reality (e.g., computer generated objects displayed as overlaid on top of a representation of a physical environment) (e.g., as described above in relation to FIGS. 11A-11D).

In some embodiments, in response to detecting the first set of one or more inputs (e.g., 1105a1 and/or 1105a2) and in accordance with a determination that the second environment has the first illumination, the computer system (e.g., 1100) displays, via the display generation component, a first animation that expands the first representation of the second environment to illuminate, via the light source (e.g., 1118a-1118b and/or 1120), the first environment (e.g., a portion of the first environment) to have the first illumination. In some embodiments, in response to detecting the first set of one or more inputs and in accordance with a determination that the second environment has the second illumination, the computer system displays, via the display generation component, a second animation that expands the second representation of the second environment to illuminate, via the light source, the first environment (e.g., a portion of the first environment) to have the second illumination. In some embodiments, illuminating, via the light source, the first environment based on illumination of the second environment includes causing the light source (e.g., 1118a-1118b and/or 1120) to emanate (e.g., spread, extend, spread out) the illumination throughout the first environment from a current position of the computer system. In some embodiments, the illumination emanates equally in all directions from the current position of the computer system. In some embodiments, the illumination does not emanate equally in all directions from the current position of the computer system. In some embodiments, the first animation expands differently than the second animation (e.g., as described above in relation to FIGS. 11A-11D). Displaying a respective animation when a set of prescribed conditions is met automatically allows the computer system to display the first environment as having similar lighting conditions as the second environment, thereby performing an operation when a set of conditions has been met without requiring further user input.

In some embodiments, the first representation of the second environment includes a color (e.g., blue, red, yellow, orange, and/or black) that corresponds to (e.g., is, is based on, and/or according to) the first illumination. In some embodiments, the first representation of the second environment includes two or more colors that correspond to the first illumination. In some embodiments, the second representation of the second environment includes a color (e.g., blue, red, yellow, orange, and/or black) that corresponds to (e.g., is, is based on, and/or according to) the second illumination. In some embodiments, the first representation of the second environment includes two or more colors that correspond to the first illumination (e.g., as described above in relation to FIGS. 11A-11D). Displaying the first representation of the second environment with a color that corresponds to the first illumination when a set of prescribed conditions is met (the second environment has the first illumination) automatically allows the computer system to provide an indication to a user of the current lighting conditions of the second environment, thereby performing an operation when a set of conditions (e.g., selection of the second user interface element and not the first user interface element) has been met without requiring further user input.

In some embodiments, the first set of one or more inputs (e.g., 1105a1 and/or 1105a2) is (e.g., consist of, does not include another input that is different from, and/or is only) the input (e.g., as described above in relation to FIGS. 11A-11D).

In some embodiments, the second environment is a physical environment (e.g., real world environment and/or tangible environment). In some embodiments, the second environment is a combination of the physical environment and a virtual environment (e.g., as described above in relation to FIGS. 11A-11D). Illuminating the first environment based on the illumination of a physical environment allows the computer system to perform one or more operations in a physical environment, thereby providing improved visual feedback.

In some embodiments, the second environment is a virtual environment (e.g., computer generated environment and/or intangible environment) (e.g., as described above in relation to FIGS. 11A-11D). Illuminating the first environment based on the illumination of a virtual environment allows the computer system to at least partially immerse the user within a virtual environment, thereby providing improved visual feedback.

In some embodiments, before detecting the first set of one or more inputs (e.g., 1105a1 and/or 1105a2), the computer system (e.g., 1100) illuminates, via the light source (e.g., 1118a-1118b and/or 1120), a first subset of the first environment (e.g., less than the entirety of the first environment, and/or a portion of the first environment) without illuminating a second subset of the first environment different from the first subset of the first environment. In some embodiments, the first subset of the first environment includes a first discrete portion of the first environment and a second discrete portion of the first environment (e.g., as described above in relation to FIGS. 11A-11D). In some embodiments, the first discrete portion of the first environment and the second discrete portion of the first environment are not adjacent to each other. Illuminating the first subset of the first environment without illuminating the second subset of the first environment before detecting the first set of one or more inputs allows the computer system to provide lighting within the first environment to enable a user to view the respective representation of the second environment, thereby providing improved feedback and/or performing an operation when a set of conditions (e.g., the first set of one or more inputs has not been detected) has been met.

In some embodiments, the light source (e.g., 1118a-1118b and/or 1120) includes a first external light (e.g., an illumination device, a point light source, a spotlight, and/or one or more light sources) and a second external light (e.g., an illumination device, a point light source, a spotlight, and/or one or more light sources) different from the first external light. In some embodiments, the first external light and the second external light are the same types of lights (e.g., as described above in relation to FIGS. 11A-11D). In some embodiments, the first external light and the second external light are different types of light. In some embodiments, the first external light and the second external light output the same amount of illumination. In some embodiments, the first external light and the second external light output different amounts of illumination. In some embodiments, the first external light and the second external light output different colors of light. In some embodiments, the first external light and the second external light output the same color of light.

Note that details of the processes described above with respect to method 1200 (e.g., FIG. 12) are also applicable in an analogous manner to the methods described herein. For example, method 700 optionally includes one or more of the characteristics of the various methods described herein with reference to method 1200. For example, illumination can be provided within a physical space based on an external environment using one or more techniques described herein in relation to method 1200, where the diffusion pattern of the physical space can be saved using one or more techniques described herein in relation to method 700. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the illumination of a physical space. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for illuminating a physical space. Accordingly, use of such personal information data enables users to have a computer system perform operations that result in the illumination of a physical space. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to some services, or publicly available information.

What is claimed is:

1. A method, comprising:
at a computer system that is in communication with a light source, an input device, and a display generation component:
while causing a first environment to be illuminated by the light source, displaying, via the display generation component, a user interface element including:
in accordance with a determination that a second environment, different from the first environment, has a first illumination, a first representation of the second environment, wherein the first representation has a first appearance based on the first illumination; and
in accordance with a determination that the second environment has a second illumination different from the first illumination, a second representation of the second environment, wherein the second representation has a second appearance based on the second illumination, and wherein the second appearance is different from the first appearance;
detecting, via the input device, a first set of one or more inputs, wherein the first set of one or more inputs includes an input corresponding to the user interface element; and
in response to detecting the first set of one or more inputs, illuminating, via the light source, the first environment based on illumination of the second environment.

2. The method of claim 1, wherein the user interface element is displayed in response to the computer system detecting a telecommunications request from a first external computer system.

3. The method of claim 2, wherein the first external computer system is positioned within the second environment.

4. The method of claim 2, wherein the first external computer system is positioned within a third environment different from the second environment and the first environment.

5. The method of claim 1, further comprising:
in response to detecting the first set of one or more inputs, initiating a first telecommunications connection between the computer system and a second external computer system.

6. The method of claim 5, wherein initiating the first telecommunications connection between the computer system and the second external computer system includes displaying, via the display generation component, a representation corresponding to the second external computer system, wherein the representation of the second external computer system is received from the second external computer system.

7. The method of claim 5, wherein the user interface element is a first user interface element, the method further comprising:
after illuminating the first environment based on the illumination of the second environment:
while causing the first environment to be illuminated by the light source, displaying, via the display generation component:
the first user interface element; and
a second user interface element different from the first user interface element;
while displaying the first user interface element and the second user interface element, detecting an input corresponding to selection of the second user interface element; and
in response to detecting the input corresponding to selection of the second user interface element, initiating a second telecommunications connection between the computer system and the second external computer system without changing the illumination of the first environment.

8. The method of claim 1, wherein the computer system is a head-mounted computer system.

9. The method of claim 1, further comprising:
in response to detecting the first set of one or more inputs:
in accordance with a determination that the second environment has the first illumination, displaying, via the display generation component, a first animation that expands the first representation of the second environment to illuminate, via the light source, the first environment to have the first illumination; and
in accordance with a determination that the second environment has the second illumination, displaying, via the display generation component, a second animation that expands the second representation of the second environment to illuminate, via the light source, the first environment to have the second illumination.

10. The method of claim 1, wherein the first representation of the second environment includes a color that corresponds to the first illumination.

11. The method of claim 1, wherein the first set of one or more inputs is the input.

12. The method of claim 1, wherein the second environment is a physical environment.

13. The method of claim 1, wherein the second environment is a virtual environment.

14. The method of claim 1, further comprising:
before detecting the first set of one or more inputs, illuminating, via the light source, a first subset of the first environment without illuminating a second subset of the first environment different from the first subset of the first environment.

15. The method of claim 1, wherein the light source includes a first external light and a second external light different from the first external light.

16. A non-transitory computer-readable storage medium storing one or more programs configured to be executed by one or more processors of a computer system that is in communication with a light source, an input device, and a display generation component, the one or more programs including instructions for:
while causing a first environment to be illuminated by the light source, displaying, via the display generation component, a user interface element including:
in accordance with a determination that a second environment, different from the first environment, has a first illumination, a first representation of the second environment, wherein the first representation has a first appearance based on the first illumination; and
in accordance with a determination that the second environment has a second illumination different from the first illumination, a second representation of the second environment, wherein the second representation has a second appearance based on the second illumination, and wherein the second appearance is different from the first appearance;
detecting, via the input device, a first set of one or more inputs, wherein the first set of one or more inputs includes an input corresponding to the user interface element; and
in response to detecting the first set of one or more inputs, illuminating, via the light source, the first environment based on illumination of the second environment.

17. A computer system configured to communicate with a light source, an input device, and a display generation component, comprising:
one or more processors; and
memory storing one or more programs configured to be executed by the one or more processors, the one or more programs including instructions for:
while causing a first environment to be illuminated by the light source, displaying, via the display generation component, a user interface element including:
in accordance with a determination that a second environment, different from the first environment, has a first illumination, a first representation of the second environment, wherein the first representation has a first appearance based on the first illumination; and
in accordance with a determination that the second environment has a second illumination different from the first illumination, a second representation of the second environment, wherein the second representation has a second appearance based on the second illumination, and wherein the second appearance is different from the first appearance;
detecting, via the input device, a first set of one or more inputs, wherein the first set of one or more inputs includes an input corresponding to the user interface element; and
in response to detecting the first set of one or more inputs, illuminating, via the light source, the first environment based on illumination of the second environment.
